(19) United States
(12) Patent Application Publication
(10) Pub. No.: US 2012/0262940 A1
(43) Pub. Date: Oct. 18, 2012

(54) Light Guide Element, Backlight Unit, and Display Device

(75) Inventors: Hidekazu MIYAIRI, Atsugi (JP); Emi KOEZUKA, Asugi (JP); Koichiro TANAKA, Isehara (JP)

(73) Assignee: Semiconductor Energy Laboratory Co., Ltd.

(21) Appl. No.: 13/446,244

(22) Filed: Apr. 13, 2012

(30) Foreign Application Priority Data
Apr. 15, 2011 (JP) 2011-091520

(51) Int. Cl. G09F 13/04; F21V 8/00

(52) U.S. Cl. 362/602; 362/628

(57) ABSTRACT

An object is to provide a novel structure of a backlight unit using color-scan backlight drive, which can relieve a color mixture problem. A backlight unit including a plurality of light guide elements is used. The light guide element has a shape extended in the x direction. The light guide element has a shape of rectangular column. Grooves are provided on a bottom surface of the light guide element so as to traverse it in the y direction. Light sources are provided at the ends of the light guide element in the x direction to supply light into the light guide element. Light supplied into the light guide element is reflected by the grooves in the z direction, and emitted to the outside of the light guide element through the top surface. A reflective layer may be provided under the bottom surface of the light guide element.

### BACKGROUND OF THE INVENTION

1. Field of the Invention

The present invention relates to a light guide element, to a backlight unit including the light guide element, to a display device including the backlight unit, and to an electronic device provided with the display device including the backlight unit.

2. Description of the Related Art

Display devices ranging from large display devices such as television receivers to small display devices such as cellular phones have spread as represented by liquid crystal display devices. From now on, higher-value-added products will be needed and are being developed. In recent years, attention is attracted to the development of low-power-consumption display devices because interest in global environment is increasing and they may improve the convenience of mobile devices.

Low-power-consumption display devices include display devices displaying images with a field sequential system (also called a color-sequential display system, a time-division display system, or a successive additive color mixture display system). In the field sequential system, backlights of red (hereinafter abbreviated to R in some cases), green (hereinafter abbreviated to G in some cases), and blue (hereinafter abbreviated to B in some cases) are sequentially lit in time, and color images are produced by additive color mixture. Therefore, the field sequential system eliminates the need for a color filter for each pixel and can increase the use efficiency of light from the backlight, thereby achieving low power consumption. In a field-sequential display device, R, G, and B can be expressed with one pixel; therefore, the field-sequential display device is advantageous in that it can easily achieve high-resolution images.

Field sequential drive has a unique problem of display defect such as color breakup (also referred to as color break). It is known that increasing the frequency of image signal inputs in a certain period can relieve the color breakup problem.

Patent Document 1 and Non-Patent Document 1 each disclose the structure of a field-sequential liquid crystal display device in which a display region is divided into a plurality of regions and a corresponding backlight unit is also divided into a plurality of regions in order to increase the frequency of image signal inputs in a certain period.

### REFERENCE

### Patent Document

Patent Document 1: Japanese Published Patent Application No. 2006-220685

### Non-Patent Document

Non-Patent Document 1: Wen-Chih Tai et al., “Field Sequential Color LCD-TV Using Multi-Area Control Algorithm”, Proc. SID '08 Digest, pp. 1092-1095.

### SUMMARY OF THE INVENTION

In each of the structures disclosed in Patent Document 1 and Non-Patent Document 1, a display region is divided into a plurality of regions to perform field sequential drive. The backlight unit is also divided into a plurality of regions each corresponding to one of the plurality of regions in the display region, and light are selectively emitted from the respective regions. Here, display defect occurs if not only a corresponding region in the display region but also a region adjacent to the corresponding region are irradiated with light emitted from one region of the backlight unit.

Note that, with display defect, the viewer sees an image mixed with light of a color different from a predetermined color. For this reason, display defect is hereinafter called a color mixture problem. In addition, in the case where field sequential drive is performed with the display region divided into a plurality of regions and the backlight unit also divided into a plurality of regions each corresponding to one of the plurality of regions in the display region, a method for driving the backlight unit is called color-scan backlight drive (or scan backlight drive).

A description will be given of the color mixture problem in the case where color-scan backlight drive is performed, with reference to schematic views of FIGS. 19A to 19C. FIG. 19A schematically illustrates the structure of a backlight unit. FIG. 19A illustrates components of a backlight unit 900: a light source unit 901, a light emission surface 902, and a diffuser sheet 903. The backlight unit 900 is a direct-lit backlight unit in which the light source unit 901 is made to overlap the light emission surface 902. Note that the light emission surface 902 is used to schematically show the scene where light from the light source unit 901 passes through the diffuser sheet 903 and is emitted to a plurality of regions. The light emission surface 902 is actually a surface of the diffuser sheet 903.

Note that although not illustrated in FIG. 19A, a display panel including a display element is made to overlap the backlight unit 900. For example, in a liquid crystal display device, a display panel has a region where liquid crystal elements and switching elements controlling whether light from the backlight unit is transmitted or not are arranged in a matrix. The region serves as a display region.

In the light source unit 901 illustrated in FIG. 19A, a plurality of light sources 911 that have a color combination producing white by additive color mixture are arranged in a matrix. The structure in which the light source unit 901 is divided into a first light source region 912, a second light source region 913, and a third light source region 914 in accordance with the division of the display region is illustrated. In the light source unit 901, red (R) light-emitting diodes 915, green (G) light-emitting diodes 916, and blue (B) light-emitting diodes 917 are illustrated as the components of the light source 911 that has a color combination producing white by additive color mixture.

In the light emission surface 902 illustrated in FIG. 19A, a first region 921, a second region 922, and a third region 923 are illustrated as regions each corresponding to one of the first light source region 912, the second light source region 913, and the third light source region 914. FIG. 19B illustrates the first region 921, the second region 922, and the third region 923 in the light emission surface 902. The rectangular regions each have the longitudinal direction 931 and the lateral direction 932.

Suppose, for example, that the green (G) light-emitting diodes 916 are selected and lit in the second light source region 913, and the second region 922 emits green light. At this time, the distribution of the intensity of light emitted from the second light source region 913 in FIG. 19A is isotropically spread and is spread by the diffuser sheet 903, so that the second region 922 in the light emission surface 902 is formed. Consequently, as schematically illustrated in FIG. 19C, light emitted from the second light source region 913 enters not only the second region 922 but also around the boundaries between the second region 922 and the adjacent first region 921 and between the second region 922 and the adjacent third region 923. Thus, color mixture regions 941 are formed.

In addition, a direct-lit backlight unit requires an increased number of light sources 911 because of an increased size of backlight units, thereby increasing manufacturing cost or power consumption.

It is an object of one embodiment of the present invention to provide a novel structure of a backlight unit using color-scan backlight drive, which can relieve the color mixture problem.

It is another object of one embodiment of the present invention to provide the structure of a backlight unit which can be manufactured at low cost.

It is another object of one embodiment of the present invention to provide the structure of a backlight unit that consumes less power.

It is another object of one embodiment of the present invention to provide the structure of a backlight unit capable of emitting highly uniform light even when made large.

It is another object of one embodiment of the present invention to provide the structure of a light guide element capable of emitting highly uniform light.

It is another object of one embodiment of the present invention to provide a display device which consumes less power and produces bright images and provides high visibility.

A backlight unit including a plurality of light guide elements is used. Each of the plurality of light guide elements has a shape of rectangular column. The light guide element has a shape extended in the x direction (longitudinal direction). Grooves are provided on a bottom surface of the light guide element so as to traverse the bottom surface in the y direction (lateral direction). Each of the grooves is formed along a direction (lateral direction) perpendicular to a longitudinal direction of the light guide element. Light sources are provided at the ends of the light guide element in the x direction to supply light into the light guide element. Light supplied into the light guide element is partly reflected by the grooves in the z direction, and emitted to the outside of the light guide element through the top surface.

By providing a medium that has a lower refractive index than the light guide element 101 around the light guide element, light supplied from the light source can be made to propagate in the x direction without providing a reflective layer on the side surfaces or the bottom surface of the light guide element. In addition, by adjusting the size of the grooves and the interval between the grooves, light can be made to propagate and go farther.

Light emission through the top surface of the light guide element is performed in such a manner that light in the light guide element is reflected by the groove traversing in the y direction. Therefore, light supplied into the light guide element is hardly emitted from the side surfaces of the light guide element, so that a color mixture problem is unlikely to occur.

One embodiment of the present invention provides a light guide element having a shape of rectangular column whose bottom surface is a surface along a longitudinal direction. The light guide element includes a groove on the bottom surface. The groove is formed so as to traverse the bottom surface in a lateral direction of the light guide element.

Light is made to enter from the ends of the light guide element into the light guide element in the longitudinal direction. At least part of the light is reflected by the groove toward a top surface opposed to the bottom surface, and then is emitted from the light guide element.

A section of the groove seen from the lateral direction is preferably curved, and preferably in a circular arc.

The material for the light guide element is preferably a material that has a higher refractive index than a medium in contact with the light guide element.

A reflective layer may be provided under the bottom surface of the light guide element as long as it is not in contact with the grooves. In this case, a space is provided between at least one of the grooves and the reflective layer, the space is filled with a medium having a lower refractive index than the light guide element. And bottom surfaces of the light guide elements are over the reflective layer.

A backlight unit including a plurality of such light guide elements is resistant to a color mixture problem and can perform scanning backlight driving.

One embodiment of the present invention may be a display device using the above-stated backlight unit.

According to one embodiment of the present invention, the color mixture problem can be relieved in the backlight unit performing color scanning backlight driving, and at the same time, light use efficiency can be improved. Further, the number of light sources used in the backlight unit can be reduced, thereby reducing manufacturing cost. Further, a backlight unit that consumes less power can be manufactured. Further, even when made large, a backlight unit enables highly uniform light to be emitted.

One embodiment of the present invention achieves at least one of the above objects.

### BRIEF DESCRIPTION OF THE DRAWINGS

FIGS. 1A and 1B are schematic views showing the structure of a backlight unit.

FIGS. 2A to 2C are schematic views showing the structures of the backlight unit and a light guide element.

FIGS. 3A to 3D are schematic views showing propagation of light in the light guide element and the intensity of light emitted from the light guide element.

FIGS. 4A to 4C are schematic views showing a relation between the light guide element and a light source.

FIGS. 5A to 5I are schematic views showing the arrangement of light sources.

FIGS. 6A and 6B are schematic views showing the cross-sectional structure of a display device including the backlight unit and a display panel.

FIGS. 7A and 7B are schematic views showing correspondences between the pixels and the backlight unit in the display device.

FIG. 8 is a timing diagram showing a method for driving the display device using a field sequential system.

FIGS. 9A to 9E are diagrams showing a relation between input of an image signal to each pixel in the display device and color scanning backlight driving.

FIGS. 10A to 10F are diagrams showing a relation between input of an image signal to each pixel in the display device and color backlight scanning.

FIGS. 11A to 11F are diagrams showing a relation between input of an image signal to each pixel in the display device and color backlight scanning.

FIG. 12 is a timing diagram showing a method for driving the display device using the field sequential system.

FIGS. 13A to 13E are diagrams showing a relation between input of an image signal to each pixel in the display device and color backlight scanning.

FIGS. 14A to 14F are diagrams showing a relation between input of an image signal to each pixel in the display device and color backlight scanning.

FIGS. 15A to 15F are diagrams showing a relation between input of an image signal to each pixel in the display device and color backlight scanning.

FIG. 16 is a timing diagram showing a method for driving the display device using the field sequential system.

FIGS. 17A1, 17A2, and 17B are top views and a cross-sectional view showing the structure of the display panel.

FIGS. 18A to 18D are diagrams showing electronic devices each including the display device.

FIGS. 19A to 19C are schematic views showing a color mixture problem in color backlight scanning.

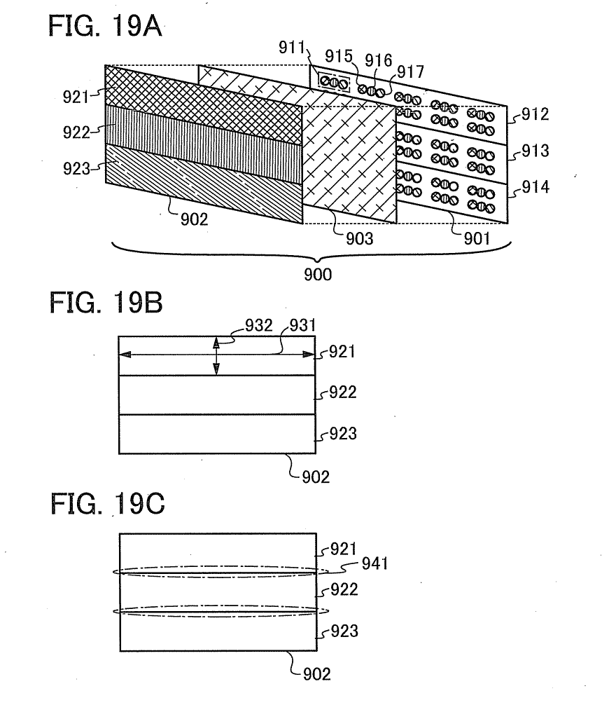

FIGS. 20A and 20B show calculation results.

FIGS. 21A and 21B show calculation results.

FIGS. 22A and 22B show calculation results.

### DETAILED DESCRIPTION OF THE INVENTION

Embodiments of the present invention will be described below with reference to the drawings. Note that the embodiments can be implemented in various different ways. It will be readily appreciated by those skilled in the art that modes and details of the embodiments can be modified in various ways without departing from the spirit and scope of the present invention. The present invention therefore should not be construed as being limited to the description of the embodiments. Note that in structures of the present invention described below, reference numerals denoting the same portions are used in common in different drawings.

Note that the size, layer thickness, or area of each component may be exaggerated for clarity in drawings and the like in the embodiments, and thus is not limited to such scales.

Note that in this specification, the tennis “first”, “second”, “third”, and “n-th” (n is a natural number) are used in order to avoid confusion among components and do not limit the number of components.

### Embodiment 1

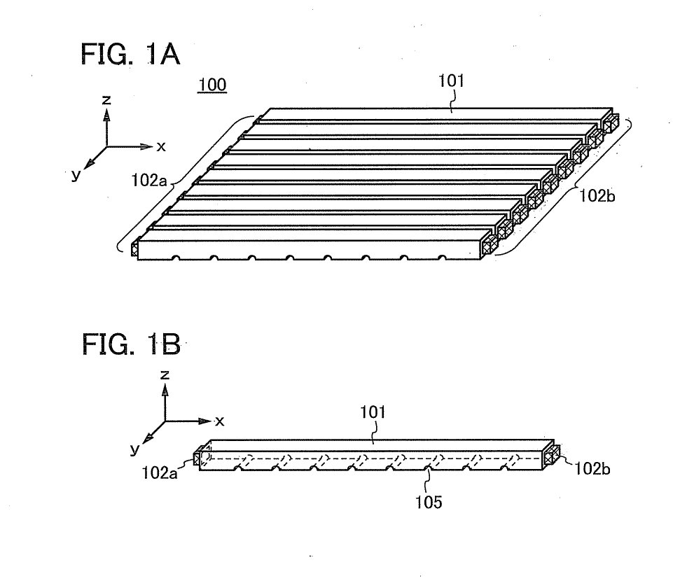

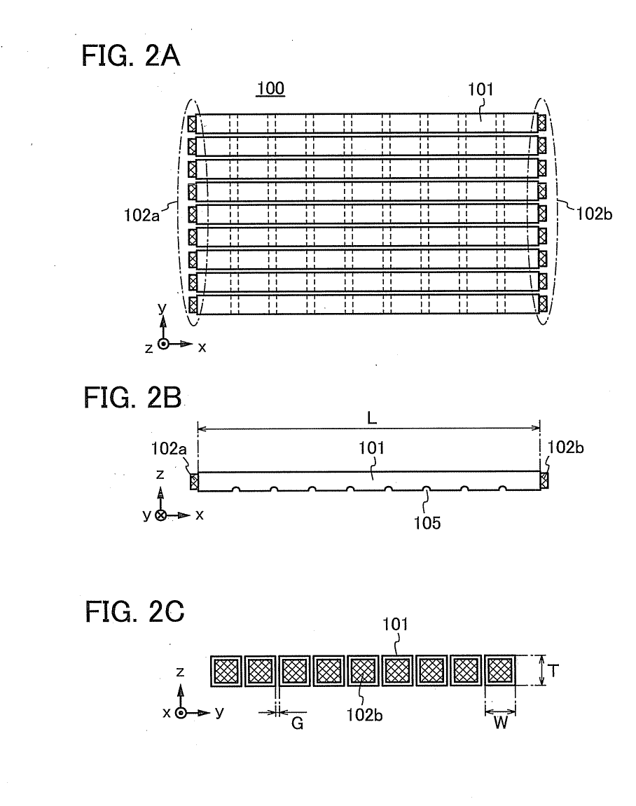

A description will be given of the structure of a backlight unit and a light guide element according to one embodiment of the present invention, with reference to FIGS. 1A and 1B and FIGS. 2A to 2C.

FIG. 1A is a perspective view schematically showing a backlight unit 100. FIG. 1B is a perspective view schematically showing one of light guide elements 101 included in the backlight unit 100. FIG. 2A is a schematic view of the backlight unit 100 viewed from the z direction. FIG. 2B is a schematic view of the backlight unit 100 viewed from the y direction. FIG. 2C is a schematic view of the backlight unit 100 viewed from the x direction. Note that the x direction, the y direction, and the z direction are orthogonal to one another.

The backlight unit 100 includes a plurality of light guide elements 101 arranged in the y direction. The light guide element 101 has a length L in the x direction, a width W in the y direction, and a thickness T in the z direction. The light guide element 101 has light sources 102a and 102b at both ends in the x direction (yz planes). Note that a structure in which a light source is provided to only one end of the light guide element 101 is acceptable. In order that the plurality of light guide elements 101 may not be in contact with one another, a gap G is provided between the adjacent light guide elements 101. Note that the gap G may be filled either with a material whose refractive index is lower than that of the light guide element 101, with air, with an inert gas, or the like. Alternatively, a light-reflective material such as a metal sheet or a metal bead may be provided thereto.

The light guide element 101 has a plurality of curved grooves 105 formed on one of two xy planes. Note that in this specification, the xy plane on which the grooves 105 are formed is called “bottom surface”, and the other xy plane is called “top surface”. In addition, an xz plane is called “side surface”. The grooves 105 are formed along the y direction of the light guide element 101 and traverse the bottom surface of the light guide element 101. Note that a surface of the groove 105 is included in “bottom surface” unless otherwise specified.

The light guide element 101 can be made of inorganic glass (with a refractive index of 1.42 to 1.7 and a transmission factor of 80% to 91%), such as quartz or borosilicate glass, or a plastic material (resin material). The plastic material can be made with any of the following resins: methacrylic resins such as polymethyl methacrylate (with a refractive index of 1.49 and a transmission factor of 92% to 93%) known as acrylic, polycarbonate (with a refractive index of 1.59 and a transmission factor of 88% to 90%), polyarylate (with a refractive index of 1.61 and a transmission factor of 85%), poly-4-methylpentene-1 (with a refractive index of 1.46 and a transmission factor of 90%), AS resin [acrylonitrile-styrene polymer] (with a refractive index of 1.57 and a transmission factor of 90%), and MS resin [methyl methacrylate-styrene polymer] (with a refractive index of 1.56 and a transmission factor of 90%). Note that the material for the light guide element 101 is not limited to this, and may be a light-transmitting material having a higher refractive index than a medium in contact with at least a side surface of the light guide element 101.

For example, the light guide elements 101 can be formed in such a manner that a surface of a substrate made of the above-described material is etched or cut to provide the grooves 105 and then cut into columns. In the case where a plastic material is used, the light guide elements 101 can also be formed by an injection molding process using a mold.

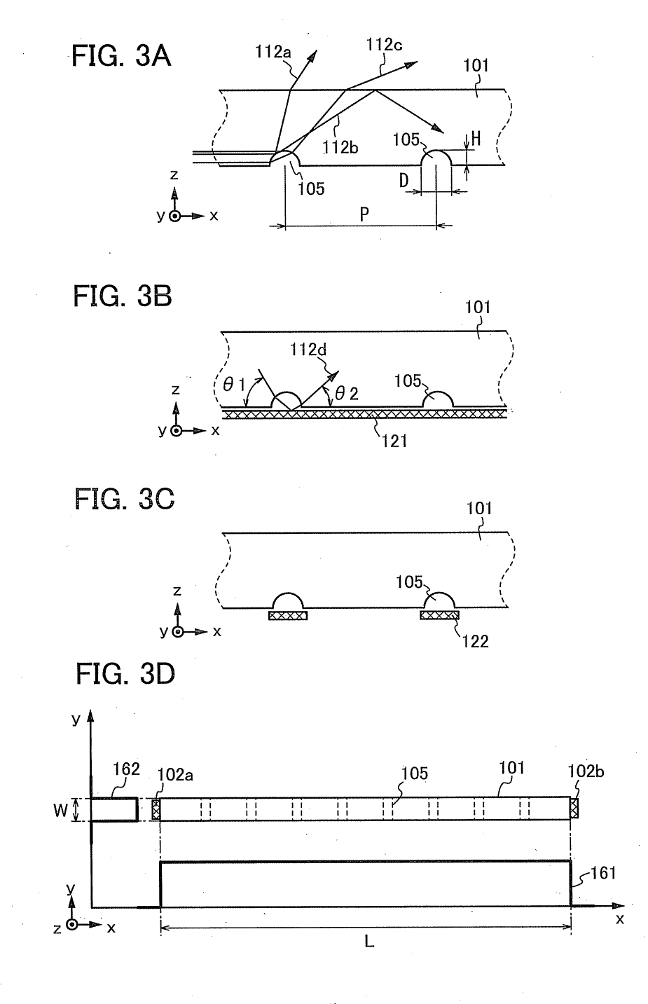

The light source 102a and the light source 102b supplies light to the light guide element 101. A description will be made of the propagation of light inside the light guide element 101 and effects of the grooves 105 with reference to FIGS. 3A to 3D.

In the case where the light guide element 101 is in contact with a medium that has a lower refractive index than that of the light guide element 101 (e.g., air), among light entering from the light sources 102a and 102b into the light guide element 101, most light entering an inner surface of the light guide element 101 at an angle smaller than a critical angle is emitted to the outside of the light guide element 101, while light entering at an angle larger than the critical angle is reflected and propagates in the x direction.

In other words, among light supplied from the light sources 102a and 102b to the light guide element 101, most light entering an inner surface of the light guide element 101 at an angle smaller than the critical angle is emitted to the outside of the light guide element 101 right after entering the light guide element 101, whereas light entering an inner surface at an angle larger than the critical angle propagates in the x direction while reflecting off the inner surface of the light guide element 101. The use of light with high directionality for the light source enables light to propagate in the x direction more efficiently.

Light 112a, light 112b, light 112c, and light 112d shown in FIGS. 3A and 3B represent light entering from the light source 102a inside the light guide element 101. FIG. 3A is an enlarged view of a part of FIG. 2B and shows the propagation of the light 112a, the light 112b, and the light 112c entering from the light source 102a shown in FIG. 2B into the light guide element 101.

The light 112a is an example of light that enters the surface of the groove 105 at an angle larger than the critical angle, is reflected toward a top surface side, enters the top surface at an angle smaller than the critical angle, and then is emitted to the outside of the light guide element 101. The light 112b is an example of light that enters the surface of the groove 105 at an angle larger than the critical angle and is reflected to a top surface side, and then enters the top surface at an angle larger than the critical angle and is reflected inside the light guide element 101. The light 112c is an example of light that enters the surface of the groove 105 at an angle larger than the critical angle and is emitted to the outside of the light guide element 101, and then passes through the groove 105 and enters into the light guide element 101 again. Subsequently, if the light 112c that has entered into the light guide element 101 again enters the top surface of the light guide element 101 at an angle smaller than the critical angle, most of the light 112c is emitted to the outside of the light guide element 101. In contrast, if the light 112c enters the top surface at an angle larger than the critical angle, the light 112c is reflected inside the light guide element 101.

FIG. 3B shows a structure in which a reflective layer 121 that reflects light is provided under the bottom surface of the light guide element 101. By providing the reflective layer 121 that reflects light under the bottom surface of the light guide element 101, light that has been emitted to the outside of the light guide element 101 can be made to enter into the light guide element 101 again, thereby increasing light use efficiency. Note that the reflective layer 121 may be in contact with the bottom surface of the light guide element 101 as long as it is not in contact with the surface of the groove 105. Therefore, a space is provided between the groove 105 and the reflective layer 121.

The light 112d is an example of light that enters the groove 105 at an angle smaller than the critical angle, is emitted from the surface of the groove 105 to the outside of the light guide element 101, is reflected by the reflective layer 121, and then enters into the light guide element 101 again. In the figure, θ1 represents the angle between the bottom surface and the light 112d entering the groove 105, while θ2 represents the angle between the bottom surface and the light 112d entering into the light guide element 101 again. Here, it is imperative that at least the surface of the groove 105 be in contact with a medium that has a lower refractive index than the light guide element 101.

Light emitted from the surface of the groove 105 to the outside of the light guide element 101 is reflected by the reflective layer 121 through a medium that has a lower refractive index than the light guide element 101, and is made to enter into the light guide element 101 again, so that θ1 and θ2 can be made different. Consequently, the angle of incidence at the inner surface of the light guide element 101 can be increased, thereby allowing light to propagate more efficiently and increasing uniformity of light emitted through the top surface of the light guide element 101. As described above, the reflective layer 121 is made to overlap the groove 105, thereby increasing light use efficiency. Note that FIG. 3C shows the case where the reflective layer 122 is formed only in a portion overlapping the groove 105.

As described above, most of the light that is either reflected by the surface of the groove 105 or passes through the groove 105, and then enters the top surface of the light guide element 101 at an angle smaller than the critical angle is emitted to the outside of the light guide element 101. Since the groove 105 is formed along the y direction, light entering the groove 105 is reflected by a side surface or the bottom surface at an angle remaining larger than the critical angle, and thus propagates in the x direction.

The top surface, bottom surface, and side surfaces of the light guide element 101 are preferably specular. When these surfaces are specular, light entering from the light source to the light guide element 101 can efficiently propagate in the x direction even if the length L of the light guide element 101 is increased. Specifically, the top surface, bottom surface, and side surfaces have a surface roughness with an arithmetic mean roughness Ra in the range of 5 nm to 1 μm, and preferably in the range of 10 nm to 500 nm.

When the surface roughness is in the above range, light entering from the light source to the light guide element 101 can efficiently propagate in the x direction even if the gap G is not provided between the adjacent light guide elements 101. In other words, when a roughness suitable for preventing light leakage due to light scattering from occurring is given particularly to the side surfaces of the light guide element 101, even if the adjacent light guide elements 101 are in contact, they are in contact at a point; therefore, a medium that has a lower refractive index than the light guide element 101 can be disposed between the adjacent light guide elements 101.

FIG. 3D is a conceptual diagram showing x-direction illumination distribution 161 and y-direction illumination distribution 162 of light emitted through the top surface of the light guide element 101. By providing the groove 105 to the bottom surface of the light guide element 101, light entering from the light sources 102a and 102b into the light guide element 101 can be efficiently emitted through the top surface.

If the groove 105 seen from the side surface of the light guide element 101 is in a shape having many straight lines such as a V shape, a rectangular shape, or a trapezoidal shape, light emitted through the top surface is prone to stripe (periodic) illumination distribution. For this reason, the groove 105 is preferably curved. Particularly the groove 105 in a circular arc is preferable because it results in desirable illumination distribution (uniformity) of light emitted through the top surface and allows the groove 105 to be easily formed, which leads to high productivity.

By adjustment of a depth H of the groove 105, a width D of the groove 105, and an interval P, desirable uniformity of light emitted through the top surface can be given even if the length L of the light guide element 101 is large. The uniformity is calculated by determining the illumination average and the standard deviation, and can be expressed as a percentage of a value obtained by dividing the value of six times the standard deviation by the illumination average. The uniformity is preferably 20% or less. The lower the uniformity, the better. With a uniformity of 20% or less, visual variations can be reduced to nearly zero.

Note that Example 1 described later shows an example of the calculation results obtained when the depth H of the groove 105, the width D of the groove 105, and the interval P are set to appropriate values. The interval P between the grooves 105 is preferably in the range of the width D of the groove 105 to 2 mm. The lower the ratio of the depth H of the groove 105 to the width D of the groove 105 (hereinafter called H/D ratio), the better the uniformity of light emitted through the top surface. The H/D ratio is preferably 0.5 or less, and more preferably in the range of 0.1 to 0.4.

The depth H of the groove 105 is in the range of a value obtained from Equation 5 to a value obtained form Equation 4 in Example 1, described later, thereby providing a desirable uniformity of light emitted through the top surface.

The grooves 105 which differ in size or H/D ratio may be used in the light guide element 101 in an appropriate combination. For example, the grooves 105 which differ in size can be disposed either periodically or aperiodically.

The interval P between the grooves 105 is not necessarily constant, and may be varied as appropriate. For example, the interval P may become smaller as it is farther from the light source or as it is closer to the center of the light guide element 101.

As described above, in the light guide element 101 with the grooves 105, leakage of light from the side surfaces hardly occurs. When the light guide elements 101 with the grooves 105 are used in a backlight unit performing color scanning backlight driving, the light emission surface of the backlight unit can be divided into a plurality of stripe regions, and the emission colors and emission states of the regions can be independently determined. Moreover, the color mixture problem can be relieved, and at the same time, light use efficiency can be increased. In addition, in the case where the backlight unit is a side-lit backlight unit in which light sources are disposed at the both ends of the light guide element 101, the number of light sources used in the backlight unit is small, resulting in low manufacturing cost and low power consumption as compared with the case where it is a direct-lit backlight unit.

Note that the backlight unit may further include a diffusion sheet, a prism sheet, or a luminance increasing sheet (also called a luminance increasing film) as needed. By providing a diffusion sheet, a prism sheet, a luminance increasing sheet, or the like on the side of the light guide element 101 through which light is emitted, the intensity distribution of light emitted from the light guide element 101 can be made more uniform and light use efficiency can be further increased.

This embodiment can be freely combined with any of the other embodiments.

### Embodiment 2

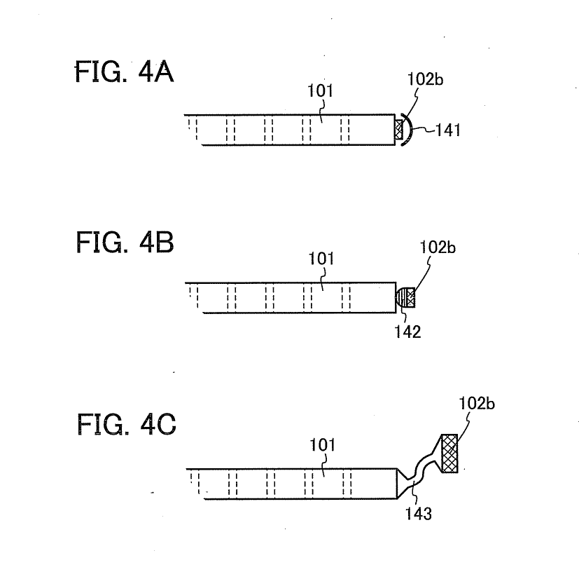

This embodiment describes an example of connection between the light guide element 101 and the light sources 102a and 102b in the backlight unit having the structure described with reference to FIGS. 1A to 1D in Embodiment 1, with reference to FIGS. 4A to 4C. The reference numerals used in FIGS. 1A to 1D will be used for the description. Note that FIGS. 4A to 4C are enlarged views of a connection point between one light guide element 101 and the light source 102b, and the same structure applies to a connection point between the light guide element 101 and the light source 102a.

FIG. 4A shows a structure in which the back of the light source 102b is provided with a reflective mirror 141. The reflective mirror 141 is disposed so as to reflect light that has failed to directly enter from the light source 102b to the light guide element 101 and to make it enter the light guide element 101. Moreover, the reflective mirror 141 allows light emitted from the end of the light guide element 101 to enter into the light guide element 101 again, which increases light use efficiency.

FIG. 4B shows a structure in which the light guide element 101 is connected to the light source 102b through a condenser lens 142. The condenser lens 142 is disposed so as to condense light emitted from the light source 102b and to make it enter the light guide element 101. The condenser lens 142 increases the directionality of light entering the light guide element 101 and allows light to more efficiently propagate in the x direction.

FIG. 4C shows a structure in which the light guide element 101 is connected to the light source 102b through an optical fiber 143. The optical fiber 143 is disposed so as to transmit light emitted from the light source 102b and allows it to enter the light guide element 101. With the optical fiber 143, the light source can be disposed away from the light guide element 101, which means that the light source can be freely placed.

The structures shown in FIGS. 4A to 4C can be used in an appropriate combination. The structures shown in FIGS. 4A to 4C allow light emitted from the light source 102b to efficiently enter the light guide element 101.

This embodiment can be freely combined with any of the other embodiments.

### Embodiment 3

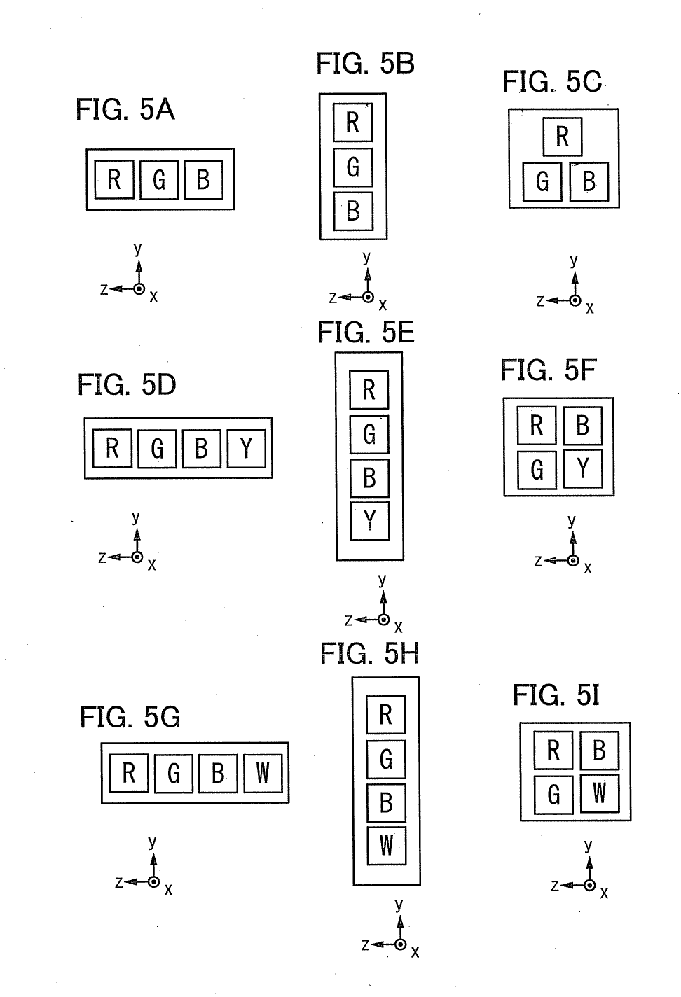

This embodiment describes an example of the structure of the light source 102a or 102b used in the backlight unit described with reference to FIGS. 1A and 1B in Embodiment 1, with reference to FIGS. 5A to 5I.

The light source 102a or 102b can be formed by the combination of a plurality of light sources, e.g., the combination of light sources of colors that produce white by addictive color mixture. For example, the light source 102a or 102b can be formed by the combination of a red light source (R), a green light source (G), and a blue light source (B). In other words, the light source 102a or 102b can be formed by the combination of a red light source (R), a green light source (G), a blue light source (B), and a light source of another color. The other color may be one or more of the following colors: yellow, cyan, magenta, and the like. Alternatively, the other color may be white. The light source can be a light-emitting diode, an organic EL element, or the like.

FIGS. 5A to 5C each illustrate an example of the arrangement of these light sources in the case where the light source 102a or 102b is fowled by the combination of a red light source (R), a green light source (G), and a blue light source (B).

FIGS. 5D to 5F each illustrate an example of the arrangement of these light sources in the case where the light source 102a or 102b is formed by the combination of a red light source (R), a green light source (G), a blue light source (B), and a light source of any one of the following colors: yellow, cyan, magenta, and the like (represented by Y in the figure).

FIGS. 5G to 5I each illustrate an example of the arrangement of these light sources in the case where the light source 102a or 102b is formed by the combination of a red light source (R), a green light source (G), a blue light source (B), and a white light source (represented by W in the figure).

Note that light of a predetermined color may be generated using a conversion filter or the like instead of providing a light source generating light of each color.

This embodiment can be freely combined with any of the other embodiments.

### Embodiment 4

This embodiment shows an example of a display device using the backlight unit described in the above embodiments. The use of the backlight unit described in the above embodiments can provide a display device that consumes less power, produces bright images, and provides high visibility.

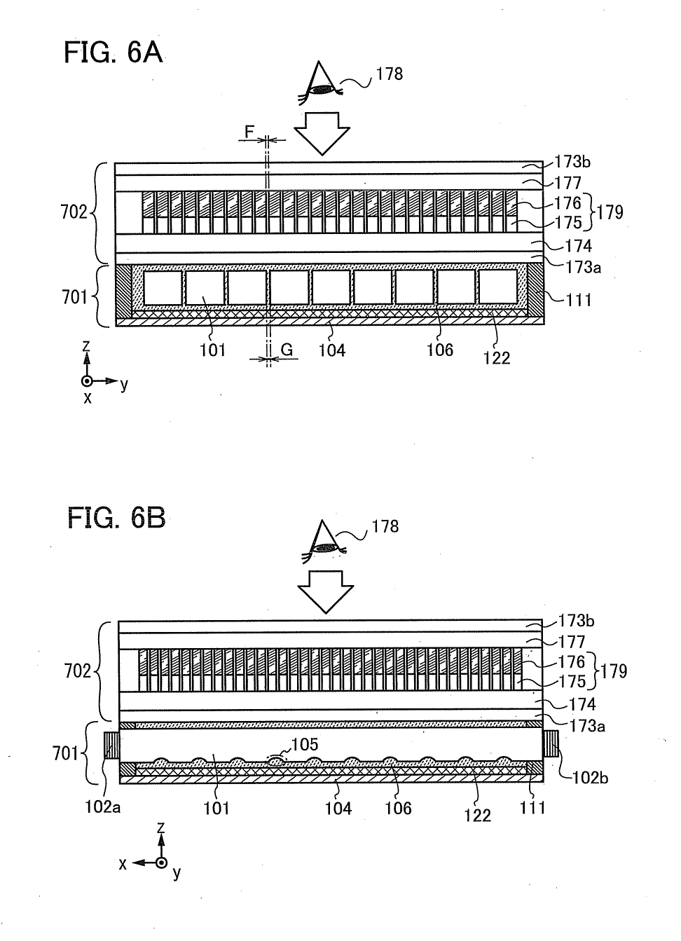

FIGS. 6A and 6B illustrate the cross-sectional structure of the display device. FIG. 6A is a cross-sectional view showing the display device viewed from the x direction. FIG. 6B is a cross-sectional view showing the display device viewed from the y direction.

In FIGS. 6A and 6B, the display device includes a backlight unit 701 and a display panel 702 disposed over one side of the backlight unit 701 which is irradiated with light from the backlight unit 701. A user's eye 178 sees the display device from the display panel 702 side and perceives an image.

The display panel 702 includes an element substrate 174, a plurality of pixels 179 provided over the element substrate 174, a substrate 177 opposed to the element substrate 174, and polarizers 173a and 173b. The element substrate 174 and the substrate 177 need to be light-transmitting substrates to transmit light emitted from the backlight unit 701. FIGS. 6A and 6B illustrate the structure in which the polarizers 173a and 173b are provided, but the present invention is not limited to this. It is acceptable that a greater number of polarizers are provided or no polarizer is provided.

The plurality of pixels 179 is arranged in a matrix over the element substrate 174. The pixel 179 can include a switching element 175 and a display element 176. The display element 176 can be a liquid crystal element. Note that the display element 176 can be any element which controls whether light is transmitted or not, and can be, for example, a micro electro mechanical system (MEMS) instead of a liquid crystal element. The switching element 175 may be a transistor. The transistor may be either a transistor containing a semiconductor such as silicon in the active layer or a transistor containing an oxide semiconductor in the active layer.

The backlight unit 701 includes a substrate 104, the light sources 102a and 102b, and the light guide element 101. The light guide element 101 is provided between the substrate 104 and the display panel 702, and is held by a support 111. In addition, the reflective layer 122 may be provided between the light guide element 101 and the substrate 104. When the substrate 104 is light-reflective, the substrate 104 can serve as the reflective layer 122. The structure of the light guide element 101 is the same as those described in other embodiments; thus, its description is omitted in this embodiment.

There is no significant limitation on the material for the substrate 104. The substrate 104 may be, for example, a glass substrate, a ceramic substrate, a substrate of a single crystal semiconductor such as silicon or silicon carbide, a polycrystalline semiconductor substrate, a semiconductor substrate of a compound such as silicon germanium, a plastic substrate, or a substrate of a metal such as a stainless steel alloy. The glass substrate may be, for example, a substrate of alkali-free glass such as barium borosilicate glass, aluminoborosilicate glass, or aluminosilicate glass, a quartz substrate, or a sapphire substrate.

FIGS. 6A and 6B illustrate the structure in which the pixels 179 are arranged in a matrix with 27 rows and 36 columns over the element substrate 174, and one light guide element 101 and pixels in a matrix with 3 rows and 36 columns are arranged so as to overlap with each other, but the present invention is not limited to this. The number of pixels 179 overlapping with one light guide element 101 can be any number. The number of light guide elements 101 can also be any number.

A gap G between the adjacent light guide elements 101 is disposed so as to overlap with a region F between the adjacent pixels 179 in the display panel 702. The region F does not affect display operation. The length of the gap G is preferably the length of the region F or less. As disclosed in Embodiment 1, the need for providing the gap G can be eliminated by giving moderate roughness to the side surfaces of the light guide element 101. In this case, the side surface of the light guide element 101 is disposed so as to overlap with the region F.

If the length of the region F is larger than that of the gap G, an optical sheet such as a diffusion sheet or a prism sheet may be provided between the backlight unit 701 and the display panel 702 to diffuse light emitted from the light guide element 101 such that the color mixture problem does not occur. Instead of providing an optical sheet, the distance between the backlight unit 701 and the display panel 702 may be increased to such an extent that the color mixture problem does not occur.

With the structure in FIGS. 6A and 6B, light from the light guide elements 101 in the backlight unit 701 enters a plurality of rows of pixels 179. In addition, the backlight unit 701 performs color scan backlight drive; thus, the display device can display images by the field sequential system.

Note that the support 111 is not provided in a region where the light guide elements 101 overlap with the pixels 179. The light guide elements 101 in the region are formed in contact with a medium 106 that has lower refractive index than the light guide element 101. Note that a difference between the refractive indexes of the light guide element 101 and the medium 106 is preferably 0.15 or more. The support 111 may be made of a light reflective material.

The medium 106 may be made, for example, of an adhesive that has lower refractive index than the light guide element 101 so that the backlight unit 701 can be secured to the display panel 702.

This embodiment can be freely combined with any of the other embodiments.

### Embodiment 5

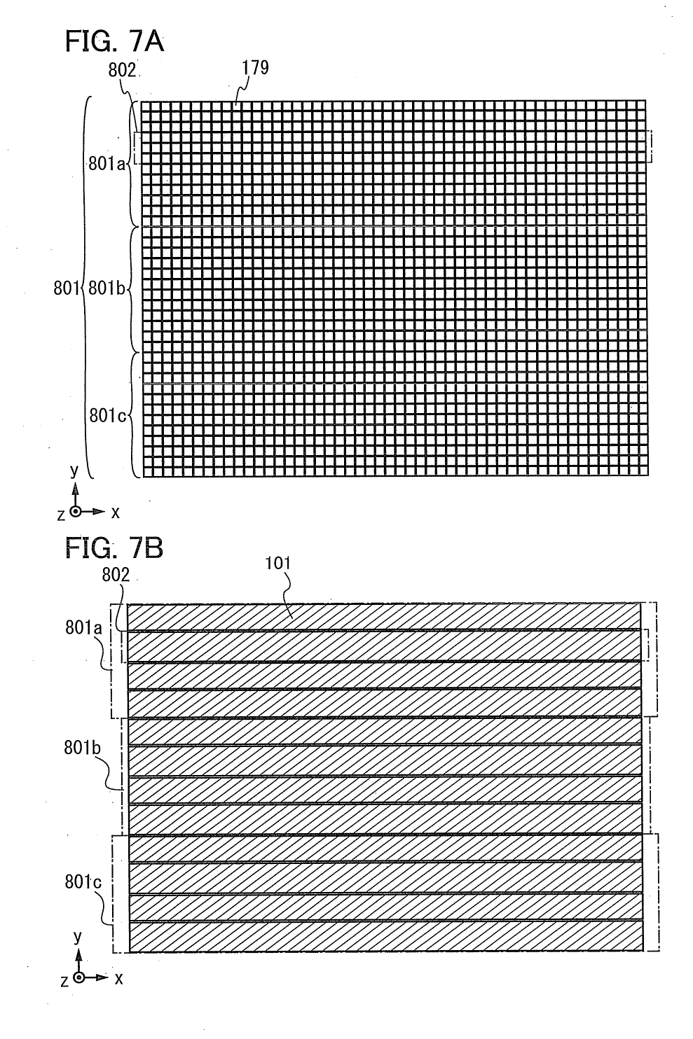

This embodiment describes an example of a method for driving a display device displaying images by the field sequential system. The description is given with reference to FIGS. 7A and 7B, FIG. 8, FIGS. 9A and 9B, FIGS. 10A to 10F, and FIGS. 11A to 11F. Note that the portions common to the figures for this embodiment and those for other embodiments are denoted by the same reference numerals and the description thereof is omitted here.

First, the specific structure of the display device will be described with reference to FIGS. 7A and 7B.

FIG. 7A is a top view of the display panel 702. The display panel 702 includes a display region 801 in which the pixels 179 are arranged in a matrix. The display region 801 is divided into a plurality of regions in the row direction (FIGS. 7A and 7B illustrate the case where the display region 801 is divided into three regions (a first region 801a, a second region 801b, and a third region 801c)). Note that the row direction in this embodiment corresponds to the cross direction in which the pixels 179 are aligned and to the lateral direction in the drawing.

FIG. 7B is a top view of the backlight unit 701 overlapping with the display panel 702 illustrated in FIG. 7A. The light guide elements 101 in the backlight unit 701 are provided so that the row direction in the display region 801 may be substantially the same as the x direction of the light guide elements 101. A plurality of light guide elements 101 (four light guide elements 101 in FIGS. 7A and 7B) overlaps with each of the plurality of regions (the first region 801a, the second region 801b, and the third region 801c). A plurality of rows of pixels (three rows of pixels in FIGS. 7A and 7B) overlaps with one light guide element 101.

Here, a set of pixels 802 corresponding to one light guide element 101 is called a block. In the structure illustrated in FIGS. 7A and 7B, the plurality of regions (the first region 801a, the second region 801b, and the third region 801c) each has first to fourth blocks. For example, in the first region 801a, the first block corresponds to the first to k-th rows in the display region 801; the second block corresponds to the (k+1)-th to 2k-th rows in the display region 801; the third block corresponds to the (2k+1)-th to 3k-th rows in the display region 801; and the fourth block corresponds to the (3k+1)-th to n-th rows in the display region 801.

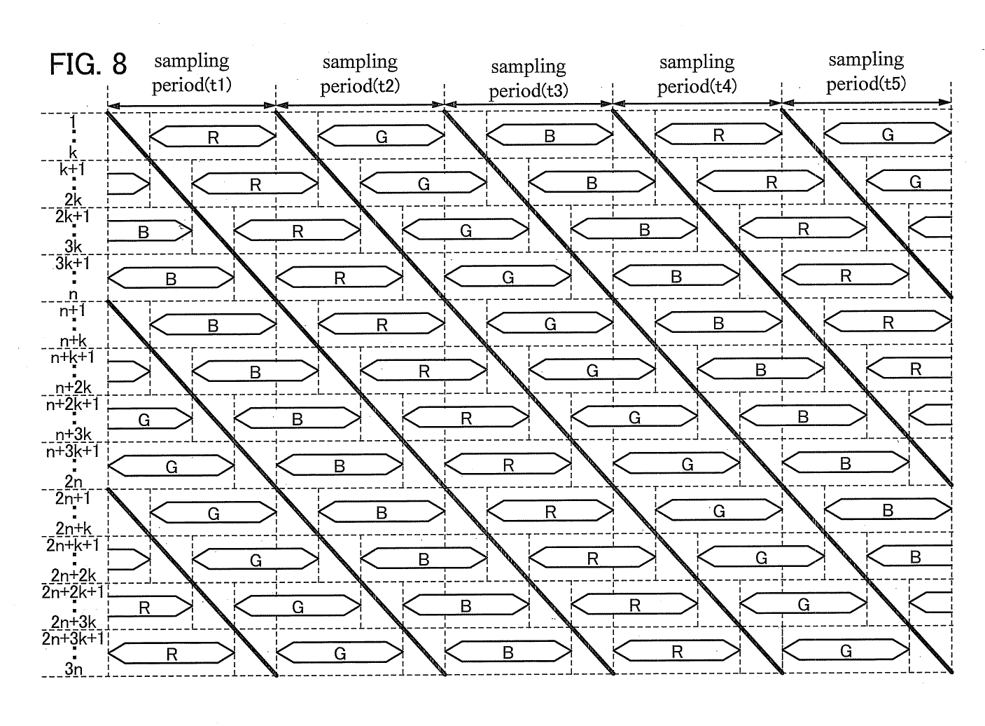

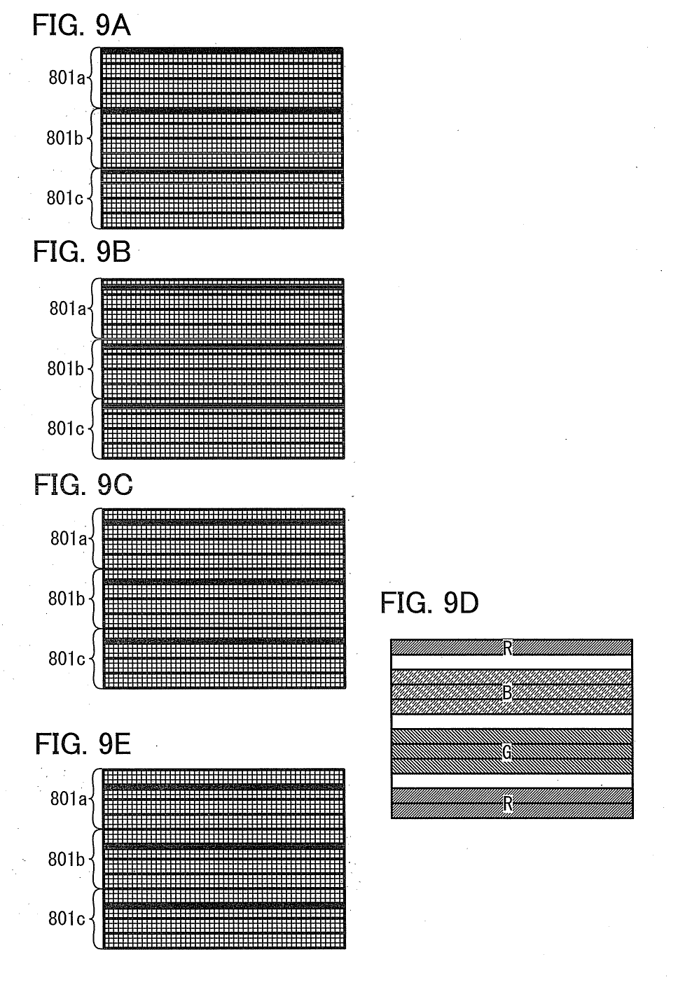

The following describes one embodiment of a method for driving a display device having the structure in FIGS. 7A and 7B in which images are displayed by the field sequential system with reference to FIG. 8, FIGS. 9A to 9E, FIGS. 10A to 10F, and FIGS. 11A to 11F.

FIG. 8 illustrates scan by a selection signal (scan in the column direction) and the timing of lighting the backlight in the display device. The selection signal controls the switching of the switching element 175 in each pixel 179. When the selection signal selects a pixel 179 as a pixel to which an image signal is input, the image signal is input to the pixel 179. The vertical axis in FIG. 8 indicates the pixel row in the display region 801 in FIGS. 7A and 7B. When the display device in FIGS. 7A and 7B employs the driving method in FIG. 8, the number k of rows in one block (k is a natural number) is 3, while the number n of rows in one region (n is a natural number) is 12.

The horizontal axis in FIG. 8 indicates time. In FIG. 8, the heavy line schematically indicates the timing of when an image signal is input to each pixel. In FIG. 8, “R” represents the phenomenon in which a plurality of pixels (e.g., the pixels in the first to k-th rows) is irradiated with light of a red luminescent color from the corresponding light guide element 101. In FIG. 8, “B” represents the phenomenon in which a plurality of pixels (e.g., the pixels in the (n+1)-th to (n+k)-th rows in a sampling period (t1)) is irradiated with light of a blue luminescent color from the corresponding light guide element 101. In FIG. 8, “G” represents the phenomenon in which a plurality of pixels (e.g., the pixels in the (2n+1)-th to (2n+k)-th rows) is irradiated with light of a green luminescent color from the corresponding light guide element 101.

On the assumption that the number of pixels in one row is m (m is a natural number), in the sampling period (t1), m (in FIGS. 7A and 7B, m is 50) pixels 179 provided in the first to n-th (in FIGS. 7A and 7B, n is 12) rows are selected in sequence, m pixels 179 provided in the (n+1)-th to 2n-th rows are selected in sequence, and m pixels 179 provided in the (2n+1)-th to 3n-th rows are selected in sequence; thus, an image signal is input to each pixel.

The driving method during the sampling period (t1) will be described in detail with reference to FIGS. 9A to 9E, FIGS. 10A to 10F, and FIGS. 11A and 11B. In FIGS. 9A to 9E, FIGS. 10A to 10F, and FIGS. 11A to 11F, black pixel rows are ones to which image signals are input. Further, R, B, and G indicate the light guide element 101 emitting red light, the light guide element 101 emitting blue light, and the light guide element 101 emitting green light, respectively. A white portion corresponds to the light guide element 101 which does not emit light (which is not lit).

At the beginning of the sampling period (t1), image signals are input to the pixels in the first, (n+1)-th, and (2n+1)-th rows simultaneously as illustrated in FIG. 9A. Then, as illustrated in FIG. 9B, image signals are simultaneously input to the pixels in the next rows: the second, (n+2)-th, and (2n+2)-th rows. In this way, in the first block in each of the plurality of regions (the first region 801a, the second region 801b, and the third region 801c), input of image signals is performed by selecting the pixel-rows one by one. Subsequently, when input of image signals to the pixels in the first block in each of the plurality of regions (the first region 801a, the second region 801b, and the third region 801c) is finished to the last pixel row as illustrated in FIG. 9C, the corresponding light guide elements 101 in the backlight unit 701 emit light as illustrated in FIG. 9D.

Note that, in FIG. 9D, the light guide elements 101 corresponding to the third and fourth blocks in the first region 801a emit blue light, the light guide elements 101 corresponding to the third and fourth blocks in the second region 801b emit green light, and the light guide elements 101 corresponding to the third and fourth blocks in the third region 801c emit red light. Image signals are input to the pixels in these blocks in a sampling period prior to the sampling period (t1), so that an image based on these image signals is displayed.

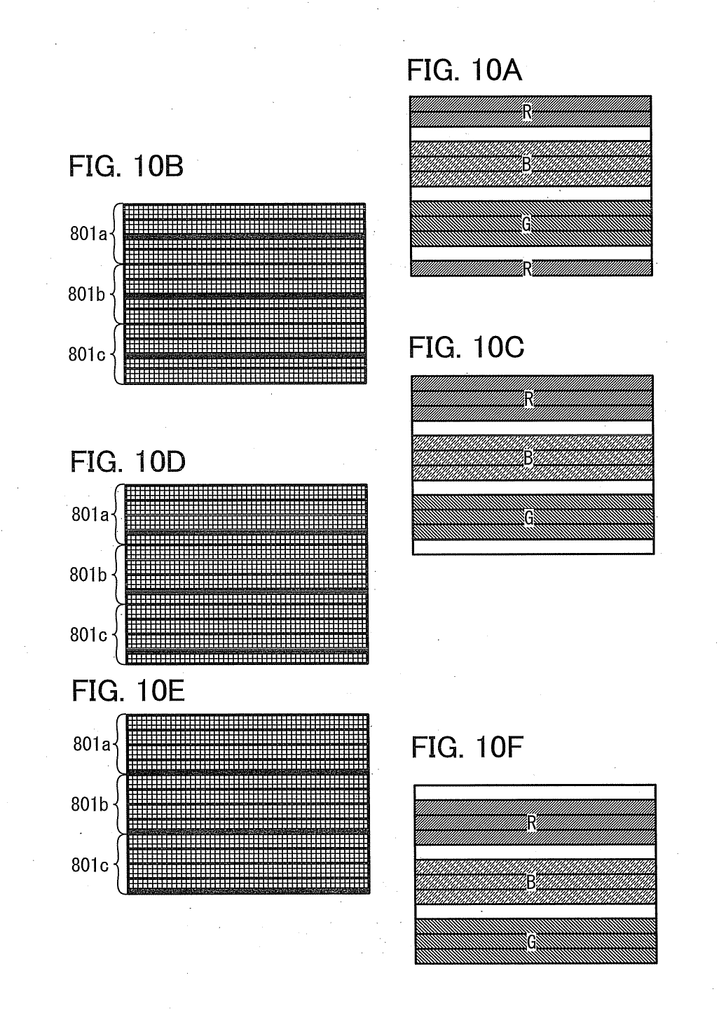

Next, in the same way, image signals are input to the pixels in the second block in each of the plurality of regions (the first region 801a, the second region 801b, and the third region 801c) as illustrated in FIG. 9E. When input of image signals to the pixels in the second block in each of the plurality of regions (the first region 801a, the second region 801b, and the third region 801c) is finished to the last pixel row, the corresponding light guide elements 101 in the backlight unit 701 emit light as illustrated in FIG. 10A. While input of image signals to the pixels in the second block is performed, the light guide elements 101 corresponding to the first, third, and fourth blocks emit light. In other words, the input of image signals and the lighting of the backlight unit 701 are done simultaneously.

The above-stated operation is also applied to the third and fourth blocks as illustrated in FIGS. 10B to 10E. Then, the sampling period (t1) terminates. The light-emission state of the backlight unit 701 after the sampling period (t1) can be like that shown in FIG. 10F. In FIG. 10F, the light guide elements 101 corresponding to the first blocks do not emit light.

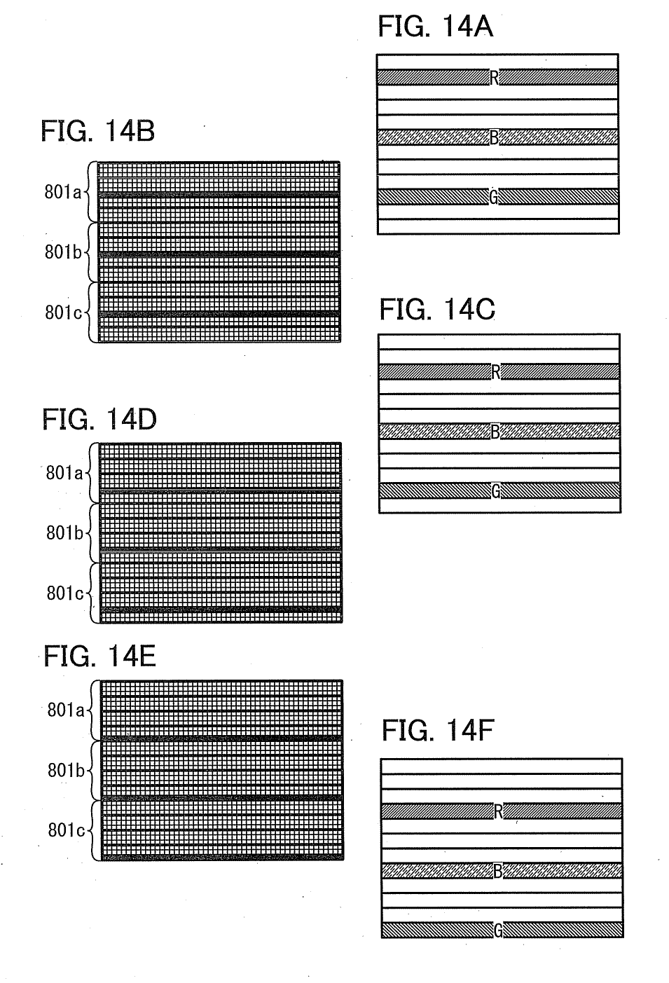

The same operation as in the sampling period (t1) is performed in the sampling period (t2) as illustrated in FIGS. 14A to 14C. However, in the plurality of regions (the first region 801a, the second region 801b, and the third region 801c), the sampling period (t1) differs from the sampling period (t2) in the color of light emitted by each light guide element 101 in the backlight unit 701. The light-emission state of the backlight unit 701 after the sampling period (t2) can be that shown in FIG. 14D. In FIG. 14D, the light guide elements 101 corresponding to the first blocks do not emit light.

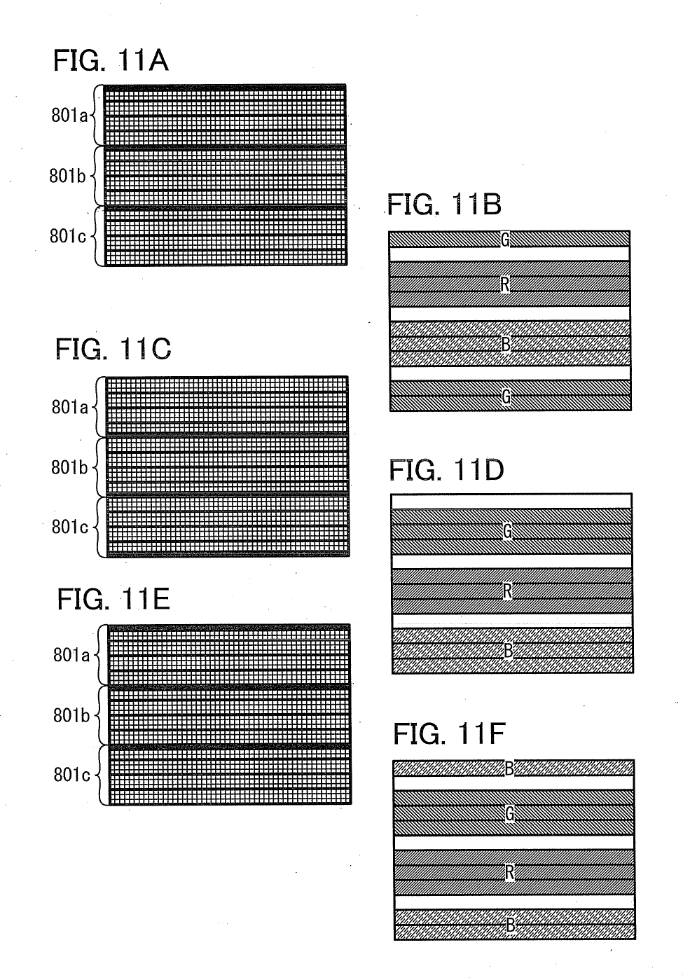

The same operation as in the sampling period (t1) or (t2) is performed in the sampling period (t3) as illustrated in FIG. 11E. However, in the plurality of regions (the first region 801a, the second region 801b, and the third region 801c), the color of light emitted by each light guide element 101 in the backlight unit 701 is different from in the sampling period (t1) or (t2). In the sampling period (t3), the light-emission state of the backlight unit 701 after the input of image signals to the pixels in the first block can be that shown in FIG. 11F. In FIG. 11F, the light guide elements 101 corresponding to the second blocks do not emit light.

Operations in the sampling periods (t1) to (t3) produce one image on the display region 801. In other words, the sampling periods (t1) to (t3) correspond to one frame period.

Note that the driving method described with reference to FIG. 8, FIGS. 9A to 9E, FIGS. 10A to 10F, and FIGS. 11A to 11F employs light of three colors: red (R), green (G), and blue (B) as a backlight, but the present invention is not limited to this. In other words, the combination of backlights producing any colors can be used. The number of the sampling periods in one frame period can be set in accordance with the number of colors used for backlights. Note that the number of sampling periods in one frame period can be set to any number. Further, one frame period may contain a period in which the backlight is not lit.

As described above, in the driving method described with reference to FIG. 8, FIGS. 9A to 9E, FIGS. 10A to 10F, and FIGS. 11A to 11F, image signals are supplied to a plurality of rows of pixels simultaneously. This can increase the frequency of input of an image signal to each pixel without changing the response speed of the switching element included in the display device, such as a transistor. For example, the driving method described with reference to FIG. 8, FIGS. 9A to 9E, FIGS. 10A to 10F, and FIGS. 11A to 11F can triple the frequency of input of an image signal to each pixel without changing the clock frequency of a driver circuit or the like.

In a field-sequential display device, color information is time-divided. Consequently, an image viewed by the user may change (degrade) from an image based on the original display data (such a phenomenon is also called color break or color breakup) owing to the miss of particular display information due to a short-time interruption of image acquisition such as the user's blinking eyes. Here, increasing the frame frequency is effective in reducing color breaks. However, in order to display an image by the field sequential system, the frequency of inputting an image signal to each pixel needs to be higher than the frame frequency. Thus, in order to display an image with a conventional display device using the field sequential system and high frame frequency drive, the elements in the display device are required to achieve extremely high performance (high-speed response). In contrast, the driving method described with reference to FIG. 8, FIGS. 9A to 9E, FIGS. 10A to 10F, and FIGS. 11A to 11F can increase the frequency of inputting an image signal to each pixel without being limited by the characteristics of the elements. This facilitates the reduction in color breaks in the field-sequential display device.

Simultaneously making different colors of light enter from the backlight unit 701 into different portions of the display region 801 as in the driving method described with reference to FIG. 8, FIGS. 9A to 9E, FIGS. 10A to 10F, and FIGS. 11A to 11F is preferable for a field-sequential display device in the following points. In the case where light of one color from the backlight unit 701 is made to enter into the whole display region 801, color information about only a particular color is present on the display region 801 in a particular moment. Therefore, the miss of display information in a particular period due to the user's blinking eyes or the like leads to the miss of particular color information. In contrast, in the case where light of different colors from the backlight unit 701 are simultaneously made to enter into different portions of the display region 801, color information about a plurality of colors is present on the display region 801 in a particular moment. Therefore, the miss of display information in a particular period due to the user's blinking eyes or the like does not lead to the miss of particular color information. In other words, simultaneously making different colors of light enter from the backlight unit 701 into different portions of the display region 801 can reduce color break. Further, in the driving method described with reference to FIG. 8, FIGS. 9A to 9E, FIGS. 10A to 10F, and FIGS. 11A to 11F, light of different colors from the backlight unit 701 are not made to enter into the adjacent blocks in the display region 801, thereby reducing influence of color mixture.

This embodiment can be freely combined with any of the other embodiments.

### Embodiment 6

This embodiment describes a method for driving a display device displaying images by the field sequential system, which is different from the driving method in Embodiment 5. Note that the portions common to the figures for this embodiment and those for other embodiments are denoted by the same reference numerals and the description thereof is omitted here.

The structure of the display device is the same as that described with reference to FIGS. 7A and 7B in Embodiment 5; thus, its specific description is omitted.

In the driving method described in Embodiment 6, the light guide elements 101 in three blocks emit light at the same time in each of the plurality of regions (the first region 801a, the second region 801b, and the third region 801c). However, the present invention is not limited to this. In each of the plurality of regions (the first region 801a, the second region 801b, and the third region 801c), the number of blocks in which the light guide elements 101 emit light at the same time can be any number:

This embodiment describes the case where, in each of the plurality of regions (the first region 801a, the second region 801b, and the third region 801c), the number of blocks in which the light guide elements 101 emit light at the same time is one.

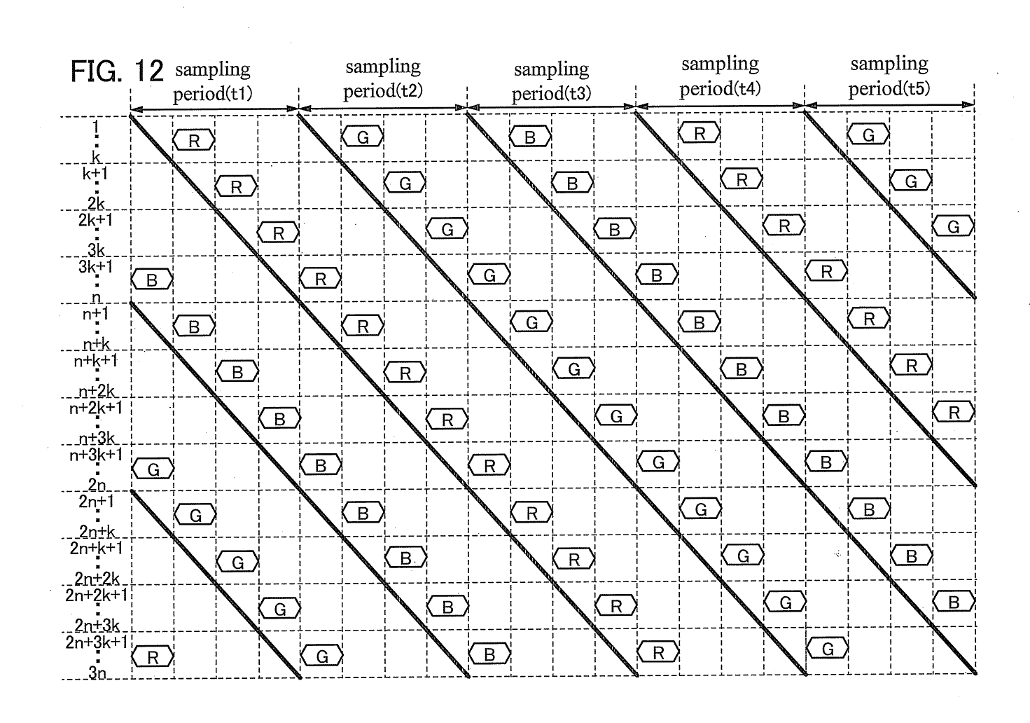

FIG. 12 illustrates scan by the selection signal (scan in the column direction) and the timing of lighting the backlight in the display device. The selection signal controls the switching of the switching element 175 in each pixel 179. When the selection signal selects a pixel 179 as a pixel to which an image signal is input, an image signal is input to the pixel 179. The vertical axis in FIG. 12 indicates the pixel row in the display region 801 in FIGS. 7A and 7B. When the display device in FIGS. 7A and 7B employs the driving method in FIG. 12, the number k of rows in one block is 3, while the number n of rows in one region is 12.

The horizontal axis in FIG. 12 indicates time. In FIG. 12, the heavy line schematically indicates the timing of when an image signal is input to each pixel. In FIG. 12, “R” represents a plurality of pixels irradiated with light of a red luminescent color from the corresponding light guide element 101. In FIG. 12, “B” represents a plurality of pixels irradiated with light of a blue luminescent color from the corresponding light guide element 101. In FIG. 12, “G” represents a plurality of pixels irradiated with light of a green luminescent color from the corresponding light guide element 101.

On the assumption that the number of pixels in one row is m (m is a natural number), in the sampling period (t1), m (in FIGS. 7A and 7B, m is 50) pixels 179 provided in the first to n-th (in FIGS. 7A and 7B, n is 12) rows are selected in sequence, in pixels 179 provided in the (n+1)-th to 2n-th rows are selected in sequence, and m pixels 179 provided in the (2n+1)-th to 3n-th rows are selected in sequence; thus, an image signal is input to each pixel.

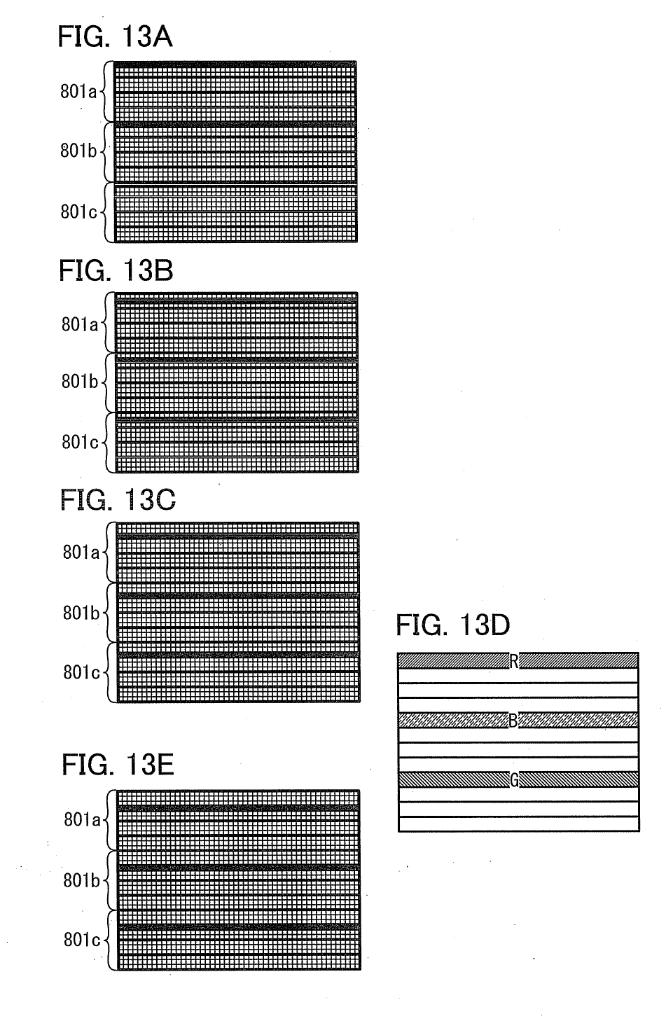

The driving method during the sampling period (t1) will be described in detail with reference to FIGS. 13A to 13E, FIGS. 14A to 14F, and FIGS. 15A to 15F. In FIGS. 13A to 13E, FIGS. 14A to 14F, and FIGS. 15A to 15F, black pixel rows are pixel rows to which image signals are input. Further, R, B, and G indicate the light guide element 101 emitting red light, the light guide element 101 emitting blue light, and the light guide element 101 emitting green light, respectively. A white portion corresponds to the light guide element 101 which does not emit light (which is not lit).

At the beginning of the sampling period (t1), image signals are input to the pixels in the first, (n+1)-th, and (2n+1)-th rows simultaneously as illustrated in FIG. 13A. Then, as illustrated in FIG. 13B, image signals are simultaneously input to the pixels in the next rows: the second, (n+2)-th, and (2n+2)-th rows. In this way, in the first block in each of the plurality of regions (the first region 801a, the second region 801b, and the third region 801c), input of image signals is performed by selecting the pixel rows one by one. Subsequently, when input of image signals to the pixels in the first block in each of the plurality of regions (the first region 801a, the second region 801b, and the third region 801c) is finished to the last pixel row as illustrated in FIG. 13C, the corresponding light guide elements 101 in the backlight unit 701 emit light as illustrated in FIG. 13D.

Next, in the same way, image signals are input to the pixels in the second block in each of the plurality of regions (the first region 801a, the second region 801b, and the third region 801c) as illustrated in FIG. 13E. When input of image signals to the pixels in the second block in each of the plurality of regions (the first region 801a, the second region 801b, and the third region 801c) is finished to the last pixel row, the corresponding light guide elements 101 in the backlight unit 701 emit light as illustrated in FIG. 14A. While input of image signals to the pixels in the second block is performed, the light guide elements 101 corresponding to the first block emit light. In other words, the input of image signals and the lighting of the backlight unit 701 are done simultaneously.

The above-stated operation is also applied to the third and fourth blocks as illustrated in FIGS. 14B to 14E. Then, the sampling period (t1) terminates. The light-emission state of the backlight unit 701 after the sampling period (t1) can be that shown in FIG. 14F.

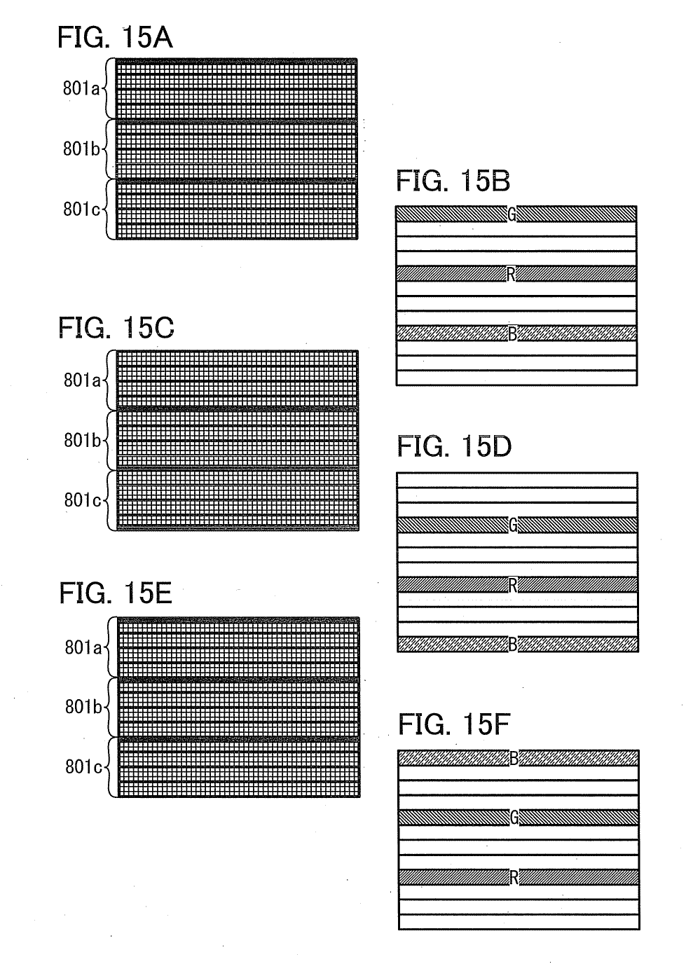

The same operation as in the sampling period (t1) is performed in the sampling period (t2) as illustrated in FIGS. 15A to 15C. However, in the plurality of regions (the first region 801a, the second region 801b, and the third region 801c), the sampling period (t1) differs from the sampling period (t2) in the color of light emitted by each light guide element 101 in the backlight unit 701. The light-emission state of the backlight unit 701 after the sampling period (t2) can be that shown in FIG. 15D.

The same operation as in the sampling period (t1) or (t2) is performed in the sampling period (t3) as illustrated in FIG. 15E. However, in the plurality of regions (the first region 801a, the second region 801b, and the third region 801c), the color of light emitted by each light guide element 101 in the backlight unit 701 is different from in the sampling period (t1) or (t2). In the sampling period (t3), the light-emission state of the backlight unit 701 after the input of image signals to the pixels in the first block can be that shown in FIG. 15F.

Operations in the sampling periods (t1) to (t3) produce one image on the display region 801. In other words, the sampling periods (t1) to (t3) correspond to one frame period.

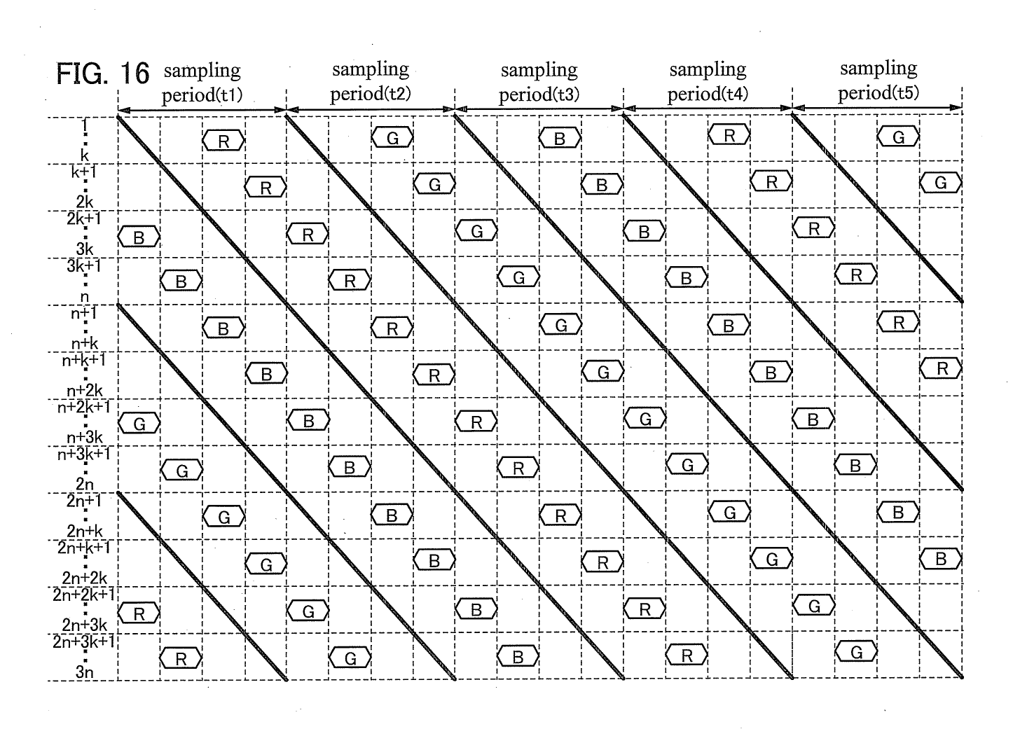

Note that the case where a light guide element 101 is made to emit light immediately after the end of input of an image signal to a corresponding pixel row has been described for the driving method described with reference to FIG. 12, FIGS. 13A to 13E, FIGS. 14A to 14F, and FIGS. 15A to 15F, but the present invention is not limited to this. The corresponding light guide element 101 may be made to emit light for a while after the end of input of an image signal. An example of such a driving method is illustrated in the timing diagram of FIG. 16. Note that this driving method is basically the same as the driving method described with reference to FIG. 12, FIGS. 13A to 13E, FIGS. 14A to 14F, and FIGS. 15A to 15F; thus, its specific description is omitted. Time from the end of the input of an image signal to when the corresponding light guide element 101 is made to emit light can be determined, for example, on the basis of the response time of the display element. This time can be determined on the basis of the response time of the liquid crystal element in the case where a liquid crystal element is used as the display element. By making the corresponding light guide element 101 emit light after adequate response of a display element such as a liquid crystal element, accurate image display based on the image signal can be achieved.

Note that the driving method described with reference to FIG. 12, FIGS. 13A to 13E, FIGS. 14A to 14F, FIGS. 15A to 15F, and FIG. 16 employs light of three colors: red (R), green (G), and blue (B) as a backlight, but the present invention is not limited to this. In other words, the combination of backlights presenting any colors can be used. The number of sampling periods in one frame period can be set in accordance with the number of colors used for backlights. Note that the number of the sampling periods in one frame period can be set to any number. Further, one frame period may contain a period in which the backlight is not lit.

As described above, in the driving method described with reference to FIG. 12, FIGS. 13A to 13E, FIGS. 14A to 14F, FIGS. 15A to 15F, and FIG. 16, image signals are supplied to a plurality of rows of pixels simultaneously. This can increase the frequency of input of an image signal to each pixel without changing the response speed of the switching element included in the display device, such as a transistor. For example, the driving method described with reference to FIG. 12, FIGS. 13A to 13E, FIGS. 14A to 14F, FIGS. 15A to 15F, and FIG. 16 can triple the frequency of input of an image signal to each pixel without changing the clock frequency of a driver circuit or the like.

In a field-sequential display device, color information is time-divided. Consequently, an image viewed by the user may change (degrade) from an image based on the original display data (such a phenomenon is also called color break or color breakup) owing to the miss of particular display information due to a short-time interruption of image acquisition such as the user's blinking eyes. Here, increasing the frame frequency is effective in reducing color breaks. However, in order to display an image by the field sequential system, the frequency of inputting an image signal to each pixel needs to be higher than the frame frequency. Thus, in order to display an image with a conventional display device using the field sequential system and high frame frequency drive, the elements in the display device are required to achieve extremely high performance (high-speed response). In contrast, the driving method described with reference to FIG. 12, FIGS. 13A to 13E, FIGS. 14A to 14F, FIGS. 15A to 15F, and FIG. 16 can increase the frequency of inputting an image signal to each pixel without being limited by the characteristics of the elements. This facilitates the reduction in color breaks in the field-sequential display device.

Simultaneously making different colors of light enter from the backlight unit 701 into different portions of the display region 801 as in the driving method described with reference to FIG. 12, FIGS. 13A to 13E, FIGS. 14A to 14F, FIGS. 15A to 15F, and FIG. 16 is preferable for a field-sequential display device in the following points. In the case where light of one color from the backlight unit 701 is made to enter into the whole display region 801, color information about only a particular color is present on the display region 801 in a particular moment. Therefore, the miss of display information in a particular period due to the user's blinking eyes or the like leads to the miss of particular color information. In contrast, in the case where light of different colors from the backlight unit 701 are simultaneously made to enter into different portions of the display region 801, color information about a plurality of colors is present on the display region 801 in a particular moment. Therefore, the miss of display information in a particular period due to the user's blinking eyes or the like does not lead to the miss of particular color information. In other words, simultaneously making different colors of light enter from the backlight unit 701 into different portions of the display region 801 can reduce color break. Further, in the driving method described with reference to FIG. 12, FIGS. 13A to 13E, FIGS. 14A to 14F, FIGS. 15A to 15F, and FIG. 16, light of different colors from the backlight unit 701 are not made to enter into the adjacent blocks in the display region 801, thereby reducing influence of color mixture. Particularly by increasing the number of the blocks in each of the plurality of regions (the first region 801a, the second region 801b, and the third region 801c) and reducing the number of blocks in which the corresponding light guide elements 101 emit light at the same time, blocks which light of different colors from the backlight unit 701 enter can be placed away from each other. This can further reduce the influence of color mixture.

This embodiment can be freely combined with any of the other embodiments.

### Embodiment 7

This embodiment shows an example of a display panel used in combination with the backlight unit in the above embodiments.

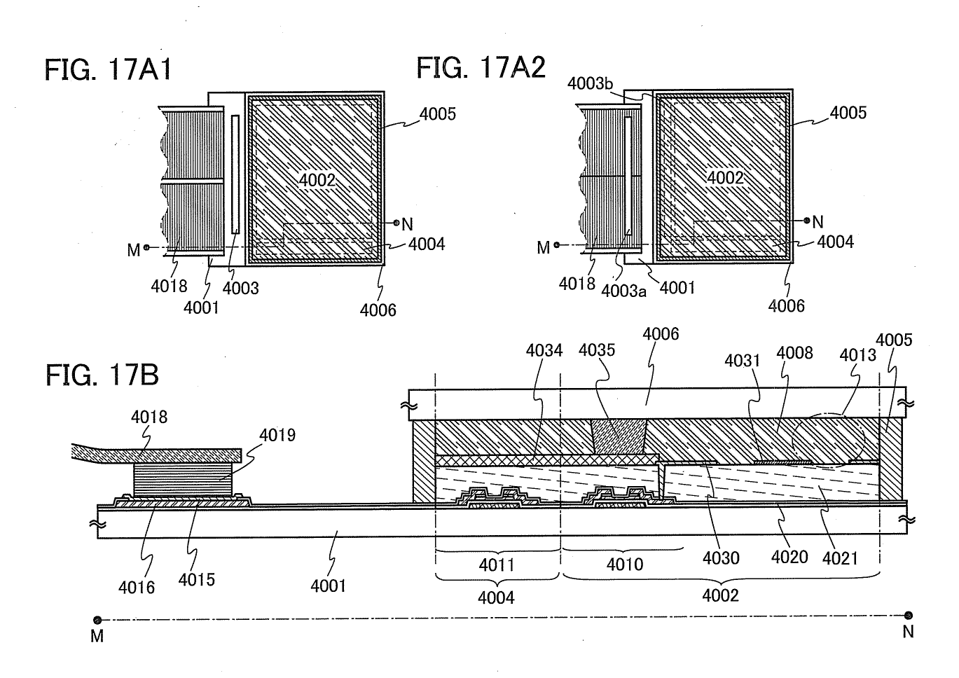

The external view and section of the display panel will be described with reference to FIGS. 17A1, 17A2, and 17B. FIGS. 17A1 and 17A2 are the top views of the display panel. FIG. 17B is a cross-sectional view along M-N in FIGS. 17A1 and 17A2.

A sealant 4005 is provided so as to surround a display region 4002 and scan line driver circuit 4004 provided over a first substrate 4001. In addition, a second substrate 4006 is provided over the display region 4002 and the scan line driver circuit 4004. The display region 4002 and the scan line driver circuit 4004 are sealed together with a liquid crystal layer 4008 by the first substrate 4001, the sealant 4005, and the second substrate 4006. The first substrate 4001 corresponds to the element substrate. The first substrate 4001 and the second substrate 4006 may be made of light-transmitting glass, plastic, or the like.

A columnar spacer 4035 is provided to control the thickness (cell gap) of the liquid crystal layer 4008. The columnar spacer 4035 can be formed by selectively etching an insulating film. Note that a spherical spacer may be used instead of the columnar spacer 4035.

In FIG. 17A1, a signal line driver circuit 4003 is mounted on a region different from the region surrounded by the sealant 4005 over the first substrate 4001. The signal line driver circuit 4003 is formed over a substrate different from the first substrate 4001 and the second substrate 4006 with the use of a single crystal semiconductor film or polycrystalline semiconductor film. FIG. 17A2 illustrates the case where a part of the signal line driver circuit is formed over the first substrate 4001 with the use of a transistor. In this case, a signal line driver circuit 4003b is formed over the first substrate 4001 and a signal line driver circuit 4003a is mounted over the first substrate 4001. The signal line driver circuit 4003a is formed over a substrate different from the first substrate 4001 and the second substrate 4006 with the use of a single crystal semiconductor film or polycrystalline semiconductor film. The scan line driver circuit may be separately formed and mounted. Alternatively, only part of the scan line driver circuit may be separately formed and mounted.

There is no particular limitation on the method of mounting a driver circuit; a COG method, a wire bonding method, a TAB method, or the like can be used. FIG. 17A1 illustrates the case where the signal line driver circuit 4003 is mounted by the COG method. FIG. 17A2 illustrates the case where the signal line driver circuit 4003 is mounted by the TAB method.

The display region 4002 and scan line driver circuit 4004 provided over the first substrate 4001 include a plurality of transistors. FIG. 17B illustrates the transistor 4010 included in the display region 4002 and the transistor 4011 included in the scan line driver circuit 4004. There is no particular limitation on the kind of the transistors 4010 and 4011, and a variety of transistors can be used. A semiconductor such as silicon (e.g., amorphous silicon, microcrystalline silicon, or polysilicon) or an oxide semiconductor can be used for an active layer (a layer in which a channel is formed) in each of the transistors 4010 and 4011.

Since a transistor is easily damaged by static electricity or the like, a protection circuit is preferably provided to a gate line which is electrically connected to the gate of the transistor or to a source line which is electrically connected to the source or the drain of the transistor. The protection circuit is preferably farmed using a non-linear element using an oxide semiconductor.

Insulating layers 4020 and 4021 are formed over the transistors 4010 and 4011. Note that one of the insulating layers 4020 and 4021 is not necessarily provided and a greater number of insulating layers may be provided over the transistors 4010 and 4011. The insulating layer 4020 serves as a protective film. The insulating layer 4021 serves as a planarization film that reduces unevenness due to the transistors and the like. The protective film is provided to prevent contaminant impurities such as an organic substance, metal, or moisture existing in the air from entering the transistors and is preferably a dense film. The protective film may be a single layer or a stacked layer of a silicon oxide film, a silicon nitride film, a silicon oxynitride film, a silicon nitride oxide film, an aluminum oxide film, an aluminum nitride film, an aluminum oxynitride film, or an aluminum nitride oxide film by sputtering. After the protective film is formed, a semiconductor layer to be the active layers of the transistors 4010 and 4011 may be annealed. The planarization film may be an organic resin film, for example.

The display region 4002 is provided with a liquid crystal element 4013. The liquid crystal element 4013 includes a pixel electrode layer 4030, a common electrode layer 4031, and the liquid crystal layer 4008. The pixel electrode layer 4030 is electrically connected to the transistor 4010. A variety of kinds of liquid crystal can be used for the liquid crystal layer 4008. For example, a liquid crystal layer exhibiting a blue phase can be used. The pixel electrode layer 4030 and the common electrode layer 4031 can be made of a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added. A conductive composition containing a conductive high molecule (also referred to as a conductive polymer) can be used for the pixel electrode layer 4030 and the common electrode layer 4031.

FIGS. 17A1, 17A2, and FIG. 17B show the case where an electrode structure used in the in plane switching (IPS) mode is employed. Note that the electrode structure is not limited to the IPS mode; an electrode structure used in the fringe field switching (FFS) mode can be employed instead.

Further, each signal and potential is supplied to the signal line driver circuit, the scan line driver circuit, or the display region 4002 from an FPC 4018. In FIGS. 17A1, 17A2, and FIG. 17B, a connection terminal electrode 4015 is formed using the same conductive film as the pixel electrode layer 4030, and a terminal electrode 4016 is formed using the same conductive film as source and drain electrode layers of the transistors 4010 and 4011. The connection terminal electrode 40.15 is electrically connected to a terminal of the FPC 4018 through an anisotropic conductive film 4019.

In FIGS. 17A1, 17A2, and FIG. 17B, a light-blocking layer 4034 is provided over the first substrate 4001 to cover the transistors 4010 and 4011. The light-blocking layer 4034 can increase the effect of stabilizing the characteristics of the transistors. Since the light-blocking layer 4034 is provided over the first substrate 4001, in the case where a liquid crystal layer exhibiting a blue phase is used as the liquid crystal layer 4008, emitting ultraviolet rays from the second substrate 4006 side for polymer stabilization in the liquid crystal allows the liquid crystal layer over the light-blocking layer 4034 to have stabilized blue phases. Note that the light-blocking layer 4034 may be provided over the second substrate 4006.

Note that a color filter is not needed for a field-sequential display device. Furthermore, unlike in the structure in which a light-blocking layer is provided to the substrate (the second substrate 4006) opposed to the element substrate, in the structure like that in FIGS. 17A1, 17A2, and 17B in which the light-blocking layer 4034 is provided over the first substrate 4001, it is acceptable that any structure is not provided over a surface of the second substrate 4006. This can simplify the process for fabricating the display device, thereby enhancing yield.

This embodiment can be freely combined with any of the other embodiments.

### Embodiment 8

A display device including the backlight unit disclosed in this specification can be used in a variety of electronic devices (including game machines). Examples of electronic devices include television sets (also referred to as televisions or television receivers), monitors of computers or the like, cameras such as digital cameras or digital video cameras, digital photo frames, cellular phone handsets (also referred to as cellular phones or cellular phone devices), portable game machines, personal digital assistants, audio reproducing devices, and large game machines such as pinball machines. The following describes examples of electronic devices each including the display device described in the above embodiments.

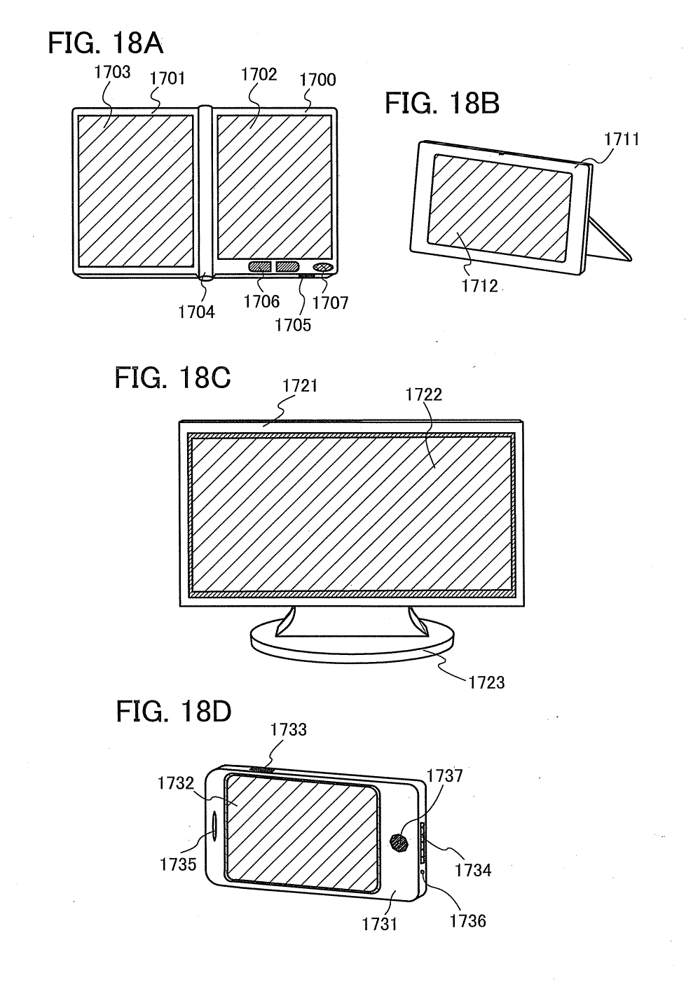

FIG. 18A illustrates an example of an e-book reader using a display device including the backlight unit disclosed in this specification. The e-book reader illustrated in FIG. 18A includes two housings 1700 and 1701. The housings 1700 and 1701 are combined with each other with a hinge 1704 so that the e-book reader can be opened and closed. With such a structure, the e-book reader can operate like a paper book.

A display region 1702 and a display region 1703 are incorporated in the housing 1700 and the housing 1701, respectively. The display region 1702 and the display region 1703 may display one image or different images. In the case where the display region 1702 and the display region 1703 display different images, for example, a display portion on the right side (the display region 1702 in FIG. 18A) can display text and a display portion on the left side (the display region 1703 in FIG. 18A) can display images.

FIG. 18A illustrates an example in which the housing 1700 includes an operation portion and the like. For example, the housing 1700 includes a power input terminal 1705, operation keys 1706, a speaker 1707, and the like. With the operation key 1706, pages can be turned. Note that a keyboard, a pointing device, or the like may be provided on the same surface as the display region of the housing. Further, an external connection terminal (e.g., an earphone terminal, a USB terminal, or a terminal that can be connected to a variety of cables such as USB cables), a recording medium insertion portion, or the like may be provided on a back surface or a side surface of the housing. Further, the e-book reader illustrated in FIG. 18A may function as an electronic dictionary.

FIG. 18B illustrates an example of a digital photo frame including a display device that includes the backlight unit disclosed in this specification. For example, in the digital photo frame illustrated in FIG. 18B, a display region 1712 is incorporated in a housing 1711. The display region 1712 can display a variety of images. For example, the display region 1712 can display data of images taken with a digital camera or the like, so that the digital photo frame can function as a normal photo frame.

Note that the digital photo frame illustrated in FIG. 18B includes an operation portion, an external connection terminal (e.g., a USB terminal or a terminal that can be connected to a variety of cables such as USB cables), a recording medium insertion portion, and the like. Although these components may be provided on the same surface as the display region, it is preferable to provide them on a side surface or a back surface for the design of the digital photo frame. For example, a memory having, data of images taken with a digital camera is inserted in the recording medium insertion portion of the digital photo frame, so that the image data can be captured and then displayed on the display region 1712.

FIG. 18C illustrates an example of a television set including a display device that includes the backlight unit disclosed in this specification. In the television set illustrated in FIG. 18C, a display region 1722 is incorporated in a housing 1721. The display region 1722 can display images. Here, the housing 1721 is supported by a stand 1723.

The television set illustrated in FIG. 18C can be operated by an operation switch of the housing 1721 or a separate remote control. Channels and volume can be controlled with operation keys of the remote control, so that images displayed on the display region 1722 can be controlled. Further, the remote control may include a display region for displaying data output from the remote control.

FIG. 18D illustrates an example of a cellular phone handset including a display device that includes the backlight unit disclosed in this specification. The cellular phone handset illustrated in FIG. 18D includes a display region 1732 incorporated in a housing 1731, operation buttons 1733 and 1737, an external connection port 1734, a speaker 1735, a microphone 1736, and the like.

The display region 1732 of the cellular phone handset illustrated in FIG. 18D is a touch panel. When the display region 1732 is touched with a finger or the like, contents displayed on the display region 1732 can be controlled. Further, operations such as making calls and composing mails can be performed by touching the display region 1732 with a finger or the like.

This embodiment can be freely combined with any of the other embodiments.

### Example 1

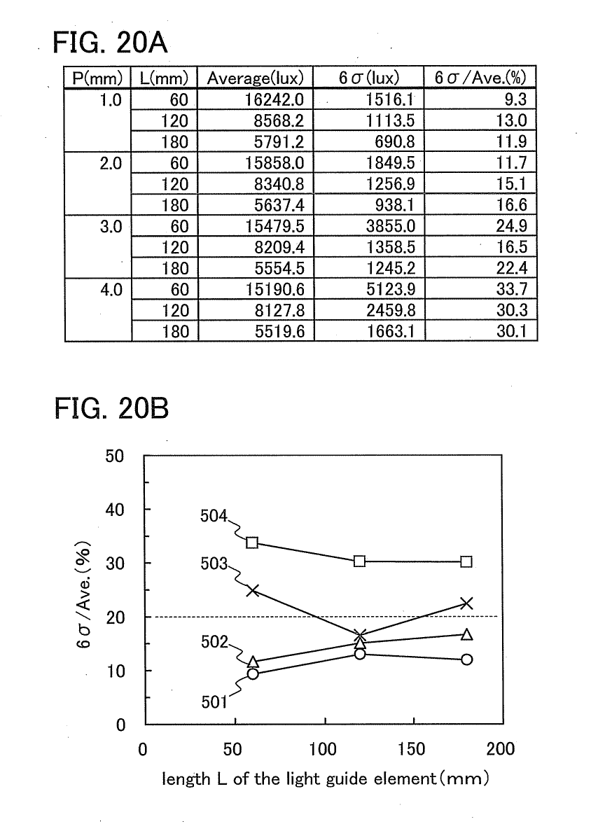

Example 1 describes, with reference to FIGS. 20A and 20B, FIGS. 21A and 21B, and FIGS. 22A and 22B, the calculation results of the depth H of the groove 105, the width D of the groove 105, the interval P between the grooves 105 which provide desirable uniformity of light emitted through the top surface of the light guide element 101 even if the length L of the light guide element 101 varies.

The calculation used illumination design and analysis software LightTools 7.1.0 from Synopsys. The depth H of the groove 105, the width D of the groove 105, the groove 105 interval P obtained when the light guide element 101 width W and the light guide element 101 thickness T are 3.7 mm and the length L of the light guide element 101 comes in 60 mm, 120 mm, and 180 mm were calculated. In this case, the H/D ratio was 0.33.

Light emitted from the light source 102a into the light guide element 101 was white light that has a luminous flux of 3 lumens and a radiation angle of ±58 degrees and is produced by mixing red light, green light, and blue light whose center wavelengths are 630 nm, 520 nm, and 470 nm, respectively. Light emitted from the light source 102b was similar to light emitted from the light source 102a.

The uniformity of light emitted through the top surface of the light guide element 101 was calculated by determining the illumination average and the standard deviation of emitted light, and was expressed as a percentage of a value obtained by dividing the value of six times the standard deviation by the illumination average. The lower the uniformity, the better. With a uniformity of 20% or less, visual variations can be reduced to nearly zero. Note that the uniformity was evaluated on the assumption that any component of light supplied from the light sources 102a and 102b into the light guide element 101 is not emitted to the outside of the light guide element 101 immediately after entering the light guide element 101.

First, the relation between the length L of the light guide element 101 and the uniformity with varying interval P was calculated. FIGS. 20A and 20B show the results of calculating the relation between the length L of the light guide element 101 and the uniformity in four light guide elements 101 having different intervals P. Note that the four light guide elements 101 have the same total area of the grooves 105. FIG. 20A shows calculation results. FIG. 20B is a graph showing the calculation results.

Plots 501, plots 502, plots 503, and plots 504 in FIG. 20B represent calculation results with an interval P of 1 mm, an interval P of 2 mm, an interval P of 3 mm, and an interval P of 4 mm, respectively.

FIGS. 20A and 20B show that, with an interval P of 2 mm or less, the uniformity is 20% or less even if the length L of the light guide element 101 varies. Note that, with an interval P that is less than the width D of the groove 105, the adjacent grooves 105 overlap with each other. In order to provide desirable uniformity without causing the adjacent grooves 105 to overlap with each other, the interval P should be determined in the range of the width D of the groove 105 to 2 mm.

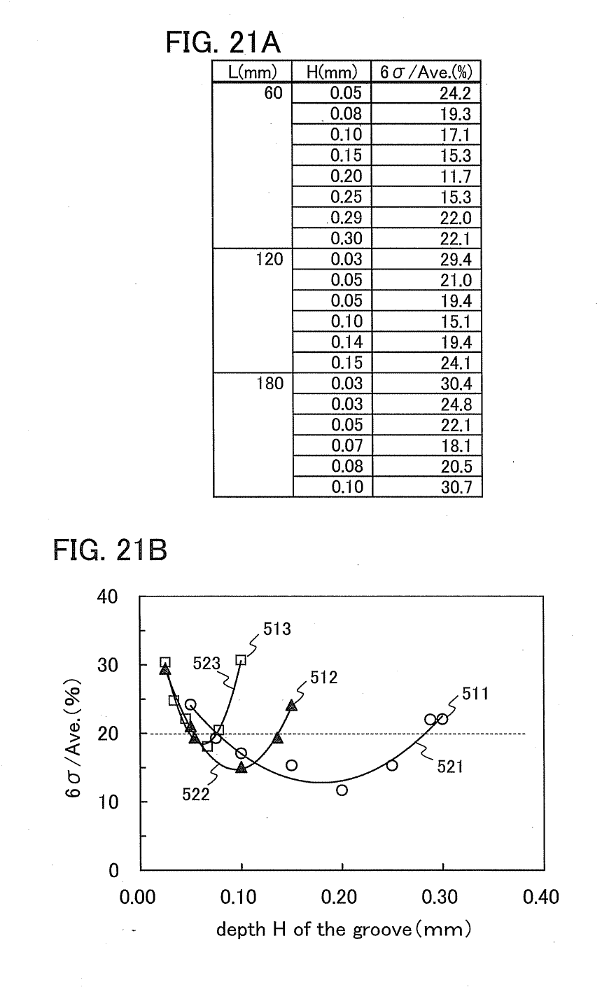

Next, the relation between the depth H of the groove 105 and the uniformity with an interval P of 2 mm and varying light guide element 101 length L was calculated. FIGS. 21A and 21B show the results of calculating the relation between the depth H of the groove 105 and the uniformity in three light guide elements 101 having different lengths L. FIG. 21A shows calculation results. FIG. 21B is a graph showing the calculation results.

Plots 511 in FIG. 21B represent calculation results with a light guide element 101 length L of 60 mm, and a curve 521 represents an approximation of the calculation results. Plots 512 represent calculation results with a light guide element 101 length L of 120 mm, and a curve 522 represents an approximation of the calculation results. Plots 513 represent calculation results with a light guide element 101 length L of 180 mm, and a curve 523 represents an approximation of the calculation results.

The curve 521, the curve 522, and the curve 523 can be expressed as Equation 1, Equation 2, and Equation 3, respectively.

Uniformity (%)=671.76H²−241.1H+34.407 [EQUATION 1]

Uniformity (%)=3007.7H²−570.72H+41.78 [EQUATION 2]

Uniformity (%)=8511.3H²−1059.9H+51.434 [EQUATION 3]

FIGS. 21A and 21B show that the depth H of the groove 105 with which a uniformity of 20% or less is achieved has upper and lower limits that depend on the length L of the light guide element 101.

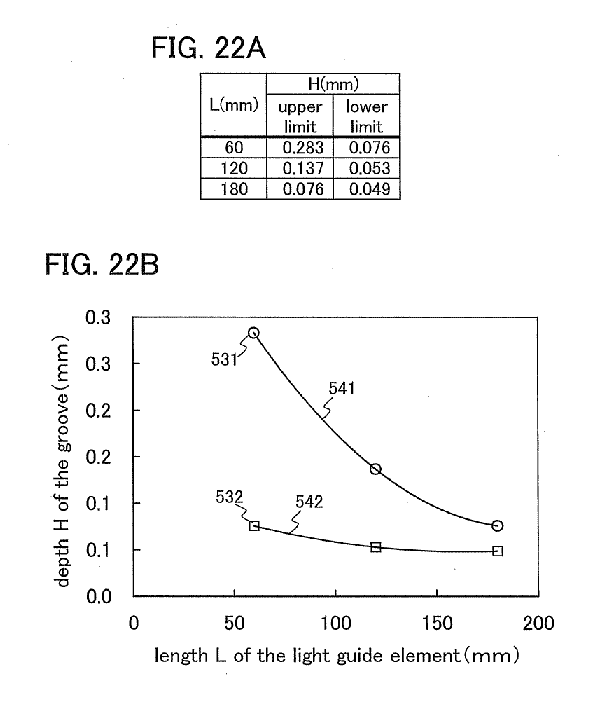

Then, the upper and lower limits of the depth H of the groove 105 with which a uniformity of 20% or less is achieved were calculated using Equation 1, Equation 2, and Equation 3. FIGS. 22A and 22B show the relation between the length L of the light guide element 101 and the depth H of the groove 105. FIG. 22A shows the upper and lower limits of the depth H with varying light guide element 101 length L, which are determined using Equation 1, Equation 2, and Equation 3. FIG. 22B is a graph showing the calculation results.

Plots 531 shown in FIG. 22B represent upper limits with light guide element 101 lengths L of 60 mm, 120 mm, and 180 mm, and a curve 541 represents an approximation of the upper limits. Plots 532 represent lower limits with light guide element 101 lengths L of 60 mm, 120 mm, and 180 mm, and a curve 542 represents an approximation of the lower limits.

The curve 541 and the curve 542 can be expressed as Equation 4 and Equation 5, respectively.

H=1×10⁻⁵L²−4.6×10⁻³L+0.515 [EQUATION 4]

H=3×10⁻⁶L²−8×10⁻⁴L+0.1172 [EQUATION 5]

As described above, the depth H of the groove 105 is set in the range of a value obtained from Equation 5 to a value obtained from Equation 4, so that the uniformity can be 20% or less even if the length L of the light guide element 101 varies.

In other words, the groove 105 interval P is set in the range of the width D of the groove 105 to 2 mm, and the depth H of the groove 105 is set in the range of a value obtained from Equation 5 to a value obtained from Equation 4, thereby achieving the light guide element 101 providing desirable uniformity of light emitted through the top surface even if the length L of the light guide element 101 varies. In addition, the width D of the groove 105 can be calculated from the H/D ratio.

This application is based on Japanese Patent Application serial No. 2011-091520 filed with Japan Patent Office on Apr. 15, 2011, the entire contents of which are hereby incorporated by reference.

What is claimed is:

1. A light guide element comprising:
a bottom surface; and
a groove on the bottom surface;
wherein the light guide element has a shape of rectangular column,
wherein the groove is formed along a direction perpendicular to a longitudinal direction of the light guide element, and
wherein the groove is filled with a medium having a lower refractive index than the light guide element.

2. The light guide element according to claim 1, wherein the medium is air.

3. The light guide element according to claim 1, wherein a section of the groove seen from the direction perpendicular to the longitudinal direction is in a circular arc.

4. The light guide element according to claim 1, wherein a ratio of a depth of the groove to a width of the groove is 0.5 or less.

5. The light guide element according to claim 1, wherein a refractive index of the light guide element is higher than a refractive index of a medium in contact with the light guide element.

6. The light guide element according to claim 1, wherein at least part of light entering from ends of the light guide element into the light guide element in the longitudinal direction is reflected by the groove toward a top surface opposed to the bottom surface.

7. A backlight unit comprising:
a plurality of light guide elements,
wherein each of the plurality of light guide elements has a shape of rectangular column,
wherein each of the plurality of light guide elements has a bottom surface,
wherein each of the plurality of light guide elements has a groove on the bottom surface,
wherein the groove is formed along a direction perpendicular to a longitudinal direction of each of the plurality of light guide elements, and
wherein the groove is filled with a medium having a lower refractive index than one of the plurality of light guide elements.

8. The backlight unit according to claim. 7, further comprising:
a reflective layer,
wherein the bottom surfaces of the plurality of light guide elements are over the reflective layer.

9. A display device comprising a backlight unit comprising:
the plurality of light guide elements according to claim 7; and
a reflective layer,
wherein the bottom surfaces of the plurality of light, guide elements are over the reflective layer.

10. A backlight unit comprising:
a reflective layer,
a light guide element having a bottom surface over the reflective layer; and
a groove on the bottom surface;
wherein the light guide element has a shape of rectangular column,
wherein the groove is formed along a direction perpendicular to a longitudinal direction of the light guide element, and
wherein the groove overlaps with the reflective layer, and
wherein a region of the reflective layer overlapping with the groove is flat.

11. The backlight unit according to claim 10, wherein a space between the groove and the reflective layer is filled with a medium having a lower refractive index than the light guide element.

12. The backlight unit according to claim 10, wherein a section of the groove seen from the direction perpendicular to the longitudinal direction is in a circular arc.

13. The backlight unit according to claim 10, wherein a ratio of a depth of the groove to a width of the groove is 0.5 or less.

14. The backlight unit according to claim 10, wherein a refractive index of the light guide element is higher than a refractive index of a medium in contact with the light guide element.

15. The backlight unit according to claim 10, wherein at least part of light entering from ends of the light guide element into the light guide element in the longitudinal direction is reflected by the groove toward a top surface opposed to the bottom surface.

16. A backlight unit comprising:
a reflective layer; and
a plurality of light guide elements each having a bottom surface over the reflective layer,
wherein each of the plurality of light guide elements has a groove on the bottom surface,
wherein the groove is formed along a direction perpendicular to a longitudinal direction of each of the plurality of light guide elements,
wherein the groove overlaps with the reflective layer, and
wherein a region of the reflective layer overlapping with the groove is flat.

17. A display device comprising the backlight unit according to claim 16.
